(19) United States
(12) Patent Application Publication
(10) Pub. No.: US 2025/0133612 A1
(43) Pub. Date: Apr. 24, 2025

(54) DYNAMIC GATEWAY SELECTION

(71) Applicant: Hughes Network Systems, LLC, Germantown, MD (US)

(72) Inventor: Solomon Kassahun, Germantown, MD (US)

(73) Assignee: Hughes Network Systems, LLC, Germantown, MD (US)

(21) Appl. No.: 18/386,937

(22) Filed: Nov. 3, 2023

Related U.S. Application Data
(63) Continuation-in-part of application No. 18/383,142, filed on Oct. 24, 2023.

(51) Int. Cl. H04W 76/12; H04W 36/18; H04W 84/06; H04W 88/16

(52) U.S. Cl. CPC H04W 76/12; H04W 36/18; H04W 84/06; H04W 88/16

(57) ABSTRACT

Methods, systems, and apparatus, including computer programs encoded on computer storage media, for dynamic gateway selection. In some implementations, a first communication tunnel is established between an SD-WAN router and a first SD-WAN gateway via a first wireless gateway. After establishing and using a modem of the terminal to communicate through the first communication tunnel, determining that the modem switched to communicate with a second wireless gateway that is different from the first wireless gateway. In response, a second SD-WAN gateway is selected based on a relationship between the second wireless gateway and the second SD-WAN gateway. Criteria for establishing an additional communication tunnel are determined to be satisfied. In response to determining that the criteria have been satisfied, a second communication tunnel between the SD-WAN router and the second SD-WAN gateway is established, the terminal is configured to provide data through the first and the second communication tunnel.

### CROSS-REFERENCE TO RELATED APPLICATION

This application is a continuation-in-part which claims the benefit of U.S. Non-Provisional application Ser. No. 18/383,142, filed on Oct. 24, 2023, and titled “Dynamic Gateway Selection,” which is incorporated by reference in its entirety.

### TECHNICAL FIELD

This specification relates generally to communication systems, including systems that perform dynamic gateway selection and communication tunnel management over wireless communication channels.

### BACKGROUND

Satellite communication systems often attempt to service devices with high efficiency. It can be desirable for a satellite communication system to communicate data to stationary and non-stationary devices without degrading network performance. This network performance can be affected by disruptions in a satellite communication link, switching between different communication mediums, physical distortions of the signal being transmitted over the widely separated geographical locations, and other causes.

### SUMMARY

In some implementations, a system manages computer network traffic on terminals that are installed in mobile stations and vehicles, such as in aircrafts, cruise ships, trains, and coaches, etc. The system can employ various techniques to provide a reliable, efficient, and cost-effective broadband connectivity that meets the demands of users accessing network services while traveling. In today's highly interconnected world, people are becoming increasingly dependent on the availability of the Internet to carry on their day-to-day lives. Wireless cellular and territorial broadband technologies have enabled people around the world to have access to the Internet not only in their homes and workplaces but also when they are commuting in cities. However, there are environments where people find limited or no access to the Internet, such as when flying in an airplane or sailing on a boat.

For example, some airlines provide in-flight connectivity to their passengers using geosynchronous or geostationary (GEO) broadband solutions. Some users can find the in-flight connectivity offered using GEO solutions to be in adequate when they are trying to access services that require high responsiveness, such as when having online conference calls. Some other airlines provide in-flight connectivity using Air-To-Ground (ATG) or low earth orbit (LEO) solutions. Some users can find the in-flight connectivity offered using ATG or LEO to be slow when accessing network services that require high capacity. Also, in-flight connectivity that is provided using ATG solutions can be interrupted when an aircraft is flying over the sea where there may not have network coverage.

Accordingly, there is a need to provide a high-throughput and low-latency broadband connectivity in a mobility environment, such as aeronautical, maritime, land-based transport, etc. This technology provides a system that can combine the merits of GEO and LEO/ATG transports to provide a reliable, high performance broadband connectivity in such environments.

To provide wireless connectivity during travel, terminals can utilize satellite communication systems that can provide broadband connectivity over a vast geographical area, including places where cellular or terrestrial communication systems do not reach, e.g., over a large body of seas and oceans. Many satellite communication systems that provide broadband connectivity services around the world utilize satellites that revolve around the Earth in the GEO orbit, which has an altitude of approximately 22,000 miles, for example. GEO satellite communication networks inherently have high latency due to the long propagation delay. Broadband connectivity with high latency may result in poor user experience when the user is accessing interactive networked services that require high responsiveness, such as real-time audio/video calls, online gaming, web browsing, etc.

Some satellite communication systems that provide broadband connectivity utilize satellites that revolve around the Earth in the LEO, which has a much lower altitude compared to GEO satellites, for example, approximately 1,200 miles or lower. LEO satellite communication systems can provide a low latency broadband connectivity service. LEO satellite communication systems can require dozens to hundreds of LEO satellites to cover the same geographical area that can be covered by a single GEO satellite, which is one of the reasons why the LEO service is typically more expensive than GEO.

In some implementations, ATG systems are used to provide broadband connectivity for aircrafts that fly in geographical areas that are covered by the ATG networks. ATG networks are characterized by their low latency and low throughput attributes. The low throughput attributes of ATG networks can often result in poor user experience as the scarcity of bandwidth slows down access to networked services, e.g., low bandwidth causes web pages to load slowly or video steams to continuously pause.

Some of the GEO/LEO satellite communication networks and ATG systems can provide broadband connectivity to mobile terminals. In these cases, a mobile terminal can communicate with a gateway on the ground using broadband connectivity provided by a satellite and/or ATG systems. Ordinarily, the movement of the terminal may cause the modem to switch from one satellite spot-beam to the next in the case of GEO/LEO satellite communication systems. Similarly, the movement of the terminal may cause frequent cellular network handovers in the case of ATG systems. Satellite spot-beam or cellular network handovers are often accompanied by gateway switchovers. The switching of gateways as the terminal moves can increase the overall latency in a system that strives to maintain persistent end-user network connections. Maintenance of end-user network connection requires complex data handling and network traffic routing when the movement of the terminal causes gateway switchovers. The complex data handling and network traffic routing often results in an increase in network latency. Additionally, the performance of broadband connectivity services provided by the satellite and ATG systems can be affected by disruptions or degradations in a satellite or cellular communication link, satellite or ATG tower handovers, physical distortions of the transmitted signal, unavailability of signal coverage in some geographical locations, and other causes.

As such, the techniques described in this specification achieve a system that provides low-latency and high-throughput broadband connectivity for terminals in mobile environments. The system can leverage aspects of a hybrid communication network, e.g., GEO systems and LEO systems or ATG systems, to meet the high-performance broadband connectivity demands of users accessing networked services while traveling. A hybrid network can include, for example, (1) a high-throughput GEO satellite and (2) a low-latency LEO system or ATG system. The system can establish one or more network SD-WAN tunnels over a hybrid network where tunnel endpoints are the mobile terminal (e.g., a terminal with software-defined wide area network (SD-WAN) capabilities) and a gateway (e.g., a SD-WAN gateway). The system leverages the merits of the hybrid network to provide reliable low-latency and high-throughput broadband connectivity that maintains end-user's persistent network connections as the terminal moves and changes locations. The system establishes new sets of SD-WAN tunnels when the movement of the terminal has caused selection of a new SD-WAN gateway, where the newly selected SD-WAN gateway provides the lowest latency path at the current location of the terminal. Existing client connections are maintained through the previous network SD-WAN tunnels and any new client connections are carried over the newly established network SD-WAN tunnels, which provide lower latency broadband connectivity relative to the tunnels established with the previous SD-WAN gateway.

In some implementations, a method includes: establishing, by a terminal, one or more first communication tunnels between a SD-WAN router of the terminal and a first SD-WAN gateway via one or more modems, including a modem that is associated to a first wireless gateway; after establishing the one or more first communication tunnels and carrying traffic from one or more client devices over the one or more first communication tunnels, detecting, by the terminal, that the modem has changed its association to a second wireless gateway that is different from the first wireless gateway; in response to detecting that the modem has changed its association to the second wireless gateway, selecting, by the terminal, a second SD-WAN gateway from a set of multiple SD-WAN gateways based on a relationship between the second wireless gateway and the second SD-WAN gateway; determining, by the terminal, whether one or more criteria for establishing an additional communication tunnel have been satisfied; and in response to determining that the one or more criteria for establishing an additional communication tunnel have been satisfied, establishing, by the terminal, one or more second communication tunnels between the SD-WAN router and the second SD-WAN gateway while maintaining the one or more first communication tunnels that the SD-WAN router established with the first SD-WAN gateway.

In some implementations, the one or more criteria comprise at least one of (i) the relationship between the second wireless gateway and the second SD-WAN gateway being maintained for at least a minimum amount of time, (ii) a limit for a maximum number of concurrently active SD-WAN registrations is not exceeded, or (iii) a minimum amount of time has elapsed since the SD-WAN router most recently established a communication tunnel with a SD-WAN gateway other than the second SD-WAN gateway.

In some implementations, the one or more modems comprise multiple modems that associate to different wireless gateways; and the method comprises monitoring each of the multiple modems to detect when any of the multiple modems changes its association to a different wireless gateway.

In some implementations, the terminal is configured to send and receive data through the one or more second communication tunnels via the second SD-WAN gateway and concurrently send and receive data through the one or more first communication tunnels via the first SD-WAN gateway.

In some implementations, the method includes: after establishing the one or more first communication tunnels with the first SD-WAN gateway and before establishing the one or more second communication tunnels, using the SD-WAN router to (i) transmit packets of a client connection over one of the first communication tunnels and (ii) receive packets of a client connection over one of the first communication tunnels; and after establishing the one or more second communication tunnels: maintaining communication over the first set of communication tunnels for existing client connections that started before the one or more second communication tunnels were established; and routing packets over the second communication tunnels for client connections that started after the one or more second communication tunnels were established.

In some implementations, detecting that the modem has changed its association comprises obtaining information from the modem using a signaling method between the terminal and the modem, and evaluating the information to detect when the modem's associated wireless gateway has changed.

In some implementations, detecting that the modem has changed its association comprises detecting when one or more connections carried by the modem have changed to a different anchor point in a network of a wireless service provider.

In some implementations, the method includes detecting a change in anchor point for one or more connections based on a change of source IP address in the one or more connections carried by the modem in the direction of transmission from the terminal to a SD-WAN gateway.

In some implementations, selecting the second SD-WAN gateway from the set of multiple SD-WAN gateways based on the relationship between the second wireless gateway and the second SD-WAN gateway comprises: selecting, from a set of multiple SD-WAN gateway locations, a second SD-WAN gateway location that has a shortest geographical distance to the location of the second wireless gateway.

In some implementations, selecting the second SD-WAN gateway from the set of multiple SD-WAN gateways based on the relationship between the second wireless gateway and the second SD-WAN gateway comprises: selecting, from a set of multiple SD-WAN gateway locations, a second SD-WAN gateway location that has a lowest latency for communication with the terminal.

In some implementations, the method includes measuring latency from the terminal to the respective multiple SD-WAN gateway locations by exchanging latency probing messages between the terminal and a server at each of the respective SD-WAN gateway locations.

In one general aspect, a method performed by one or more computers includes: establishing, by a terminal, a first communication tunnel between an SD-WAN router and a first SD-WAN gateway via a first wireless gateway; after establishing the first communication tunnel and using a modem of the terminal to communicate through the first communication tunnel via the first wireless gateway, determining, by the terminal, that the modem has switched to communicate with a second wireless gateway that is different from the first wireless gateway; in response to determining the modem is communicating with the second wireless gateway, selecting, by the terminal, a second SD-WAN gateway from a set of multiple SD-WAN gateways based on a relationship between the second wireless gateway and the second SD-WAN gateway; determining, by the terminal, whether one or more criteria for establishing an additional communication tunnel have been satisfied, wherein the one or more criteria comprise at least one of (i) the relationship between the second wireless gateway and the second SD-WAN gateway is maintained for at least a minimum amount of time, or (ii) the SD-WAN router has been registered to the second SD-WAN gateway for at least a minimum amount of time; and in response to determining that the one or more criteria for establishing an additional communication tunnel have been satisfied, establishing, by the terminal, a second communication tunnel between the SD-WAN router and the second SD-WAN gateway while maintaining the first communication tunnel, such that the terminal is configured to provide data through the second communication tunnel via the second wireless gateway and concurrently provide data through the first communication tunnel via the first wireless gateway.

The foregoing and other embodiments can each optionally include one or more of the following features, alone or in combination. For example, one embodiment includes all the following features in combination.

In some implementations, the method includes: after establishing the first communication tunnel and before establishing the second communication tunnel, establishing one or more first network connections between one or more client devices and one or more remote servers through the first communication tunnel; after establishing the second communication tunnel, establishing one or more second network connections between one or more client devices and one or more remote servers through the second communication tunnel; and concurrently communicating with the one or more first network connections on the first communication tunnel and the one or more second network connections on the second communication tunnel.

In some implementations, the method further includes: selectively routing different types of traffic between (i) the first communication tunnel between the SD-WAN router, a first modem, and the first SD-WAN gateway and (ii) the second communication tunnel between the SD-WAN router, a second modem, and the second SD-WAN gateway, wherein a first type of traffic is routed over the one or more first network connections on the first communication tunnel and a second type of traffic is routed over the one or more second network connections on the second communication tunnel.

In some implementations, determining that the modem has switched to communicate with the second wireless gateway that is different from the first wireless gateway includes: determining that the modem of the terminal switched to communicate with the second wireless gateway due to a movement of the terminal from a first geographic location to a second geographic location.

In some implementations, selecting the second SD-WAN gateway from the set of multiple SD-WAN gateways based on the relationship between the second wireless gateway and the second SD-WAN gateway includes: selecting the second SD-WAN gateway from the set of multiple SD-WAN gateways according to a distance between a location of the second SD-WAN gateway and the second wireless gateway satisfying a first threshold value; or selecting the second SD-WAN gateway from the set of multiple SD-WAN gateways including: for each SD-WAN gateway of the set of multiple SD-WAN gateways: determining a latency value according to a communication between the second wireless gateway and the SD-WAN gateway; and selecting the second SD-WAN gateway as the SD-WAN gateway whose latency value satisfies a second threshold value.

In some implementations, determining that the modem has switched to communicate with the second wireless gateway that is different from the first wireless gateway includes determining that the modem has switched to communicate with the second wireless gateway that is different from the first wireless gateway due to a change of geographic location of the terminal.

In some implementations, determining that the modem has switched to communicate with the second wireless gateway that is different from the first wireless gateway includes monitoring a status of the modem over a period of time to detect a change in wireless gateway used by the modem.

In some implementations, obtaining, by a terminal, locational information from each of a set of wireless modems using periodic signaling between the terminal and each wireless modem of the set of wireless modems, wherein the locational information comprises identification and geographical information of a wireless gateway that each wireless modem is currently connected to, wherein the wireless gateway is a device of a wireless service provider that communicates with each of the wireless modems.

In some implementations, determining, by the terminal, a preferred SD-WAN gateway location for establishing SD-WAN tunnels with an SD-WAN gateway, wherein determining the preferred SD-WAN gateway location is performed using at least one of: evaluating an SD-WAN gateway location that has the shortest geographical distance from the location of the wireless gateway which is currently associated to a low-latency transport modem; and measuring a latency of each of the SD-WAN gateway locations and selecting the location with the lowest latency; and determining the low latency transport based on the configuration obtained from an SD-WAN network management system or from an SD-WAN network operator, wherein the SD-WAN network management system or the SD-WAN network operator provides the terminal with details of candidate SD-WAN gateways that the terminal is allowed to work with.

In some implementations, each candidate SD-WAN gateway detail includes identification, IP address, and geographical location information of the SD-WAN gateway.

In some implementations, two or more SD-WAN gateways are located in the same datacenter, and sharing, by each SD-WAN gateway of the two or more SD-WAN gateways, the location of the datacenter as their geographical location.

In some implementations, generating, by the terminal, a list of unique SD-WAN gateway locations where each unique SD-WAN location is mapped to a list of SD-WAN gateways that share the same location.

In some implementations, the method includes: establishing, by a terminal, a first set of SD-WAN tunnels with an SD-WAN gateway at the preferred SD-WAN gateway location via one ore or more wireless broadband transport modems that are connected to their respective wireless gateways; and selecting, by the terminal, the SD-WAN gateway from the list of SD-WAN gateways at the same SD-WAN location by contacting all or randomly picked few of the SD-WAN gateways and selecting the SD-WAN gateway that is the least loaded.

In some implementations, selecting, by the terminal and a peered SD-WAN gateway, an SD-WAN tunnel that carries packets of a client connection, wherein selecting of the SD-WAN tunnel is performed based on a performance requirement of the client's application that generated the connection and characteristics of the broadband transport corresponding to the SD-WAN tunnel.

In some implementations, the method includes: monitoring, by the terminal, of each of the modems to detect when they have performed a switchover to a new wireless gateway, wherein monitoring each of the modems includes: receiving, by the terminal, information from each of the modems, the information comprising identification and geographical location information of a connected wireless gateway for each of the modems.

In some implementations, the method includes detecting, by the terminal, when the modem has performed a switchover to the new wireless gateway, wherein detecting the modem has switched over to a different wireless gateway in response to determining the identifier of modem's currently associated wireless gateway is different from the identifier of the wireless gateway that the modem was associated with previously.

In some implementations, the method includes selecting, by the terminal, of a new SD-WAN gateway location that becomes the new preferred from the pool of SD-WAN gateway locations.

In some implementations, the method includes: determining, by the terminal, whether one or more criteria for establishing SD-WAN tunnels with a new SD-WAN gateway at a different SD-WAN gateway location are satisfied, wherein the one or more criteria comprises at least one of: (i) the second SD-WAN gateway location remains the most preferred for at least a minimum threshold amount of time, and (ii) a limit on a maximum number of concurrently active SD-WAN gateway registrations does not satisfy a threshold, wherein satisfying the threshold indicates whether a previous SD-WAN gateway registration is to be torn down.

In some implementations, the method includes cancelling the SD-WAN tunnels established from an oldest SD-WAN gateway registration in response to determining the terminal has reached a limit on a maximum number of concurrently active SD-WAN gateway registrations and an age of the oldest SD-WAN gateway registration exceeds a configured threshold.

In some implementations, the method includes: establishing, by the terminal, a new set of SD-WAN tunnels to the new SD-WAN gateway at the second SD-WAN location in response to the one or more criteria for establishing SD-WAN tunnels with a new SD-WAN gateway from the second SD-WAN gateway location have been satisfied; and maintaining, by the terminal, the previous set of SD-WAN tunnels which were established with the previous SD-WAN gateway at the first SD-WAN gateway location.

In some implementations, the method includes: maintaining, by the terminal, existing client TCP/IP connections on the SD-WAN tunnels established with the same SD-WAN gateway that handled the connections when the connections were initiated; and maintaining, by the terminal, new client TCP/IP connections over the SD-WAN tunnels established with the new closest SD-WAN gateway.

Other embodiments of these and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1C are diagrams showing examples of a system for dynamically selecting an SD-WAN gateway location and managing SD-WAN tunnels in a wireless communication network.

FIG. 2 is a flow diagram that illustrates an example process that a terminal can use in dynamically selecting an SD-WAN gateway location that can provide the lowest expected path to the Internet.

FIG. 3 is a flow diagram that illustrates another example process that a terminal can use in dynamically selecting an SD-WAN gateway location that can provide the lowest expected path to the Internet.

Like reference numbers and designations in the various drawings indicate like elements.

### DETAILED DESCRIPTION

The specification describes a system in which a mobile terminal that combines a lower latency, lower throughput transport, such as, a Low-Earth Orbit (LEO) satellite or Air-To-Ground (ATG) WAN, with a mobile high throughput, higher latency Geosynchronous spot-beam satellite transport (GEO) takes advantage of the merits of the two transports where packets of applications that are sensitive to latency are carried by the low-latency transport and packets of high bandwidth requiring applications are carried by the high throughput transport. This system includes a mobile terminal which supports two or more WAN transports and one or more peer SD-WAN gateway(s) in one or more datacenters that provide(s) connectivity to the public Internet. In this system, the mobile terminal actively monitors its WAN modems and dynamically sets up SD-WAN tunnels with an SD-WAN gateway located in a datacenter that is best positioned to provide connectivity to the Internet with the lowest expected latency.

The technologies include, for example, (1) Mobile Internet access: (2) WAN Optimization—whereby dynamic Quality-Of-Service (QOS) is provided over WAN transports that ordinarily do not support QOS by establishing QOS overlay tunnels over the transports; (3) Mobile satellite communications—whereby geosynchronous satellites may provide a high throughput broadband connectivity to a vast geographical area, including regions that are unserved or underserved by terrestrial communication systems, but operate with an order of magnitude higher latency than LEO or ATG; (4) TCP Performance Enhancing Proxies (PEP)—whereby sender and receiver sides of TCP are proxied to reduce the effect of latency on TCP throughput on high latency transports such as GEO satellite; (5) Terrestrial wireless or cellular networking, e.g., using technologies such as 4G, LTE and 5G to provide wireless connectivity to the Internet; and (6) SD-WAN, e.g., where multiple broadband transports are combined, such as GEO+LEO or GEO+ATG, to provide better service and availability than what can be provided by either transport alone.

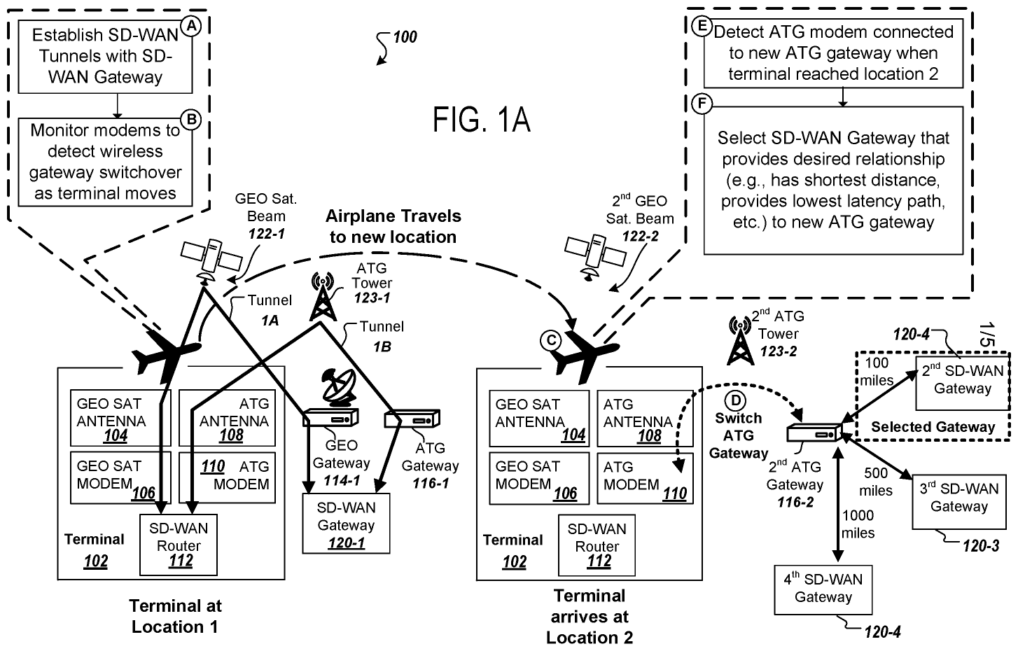

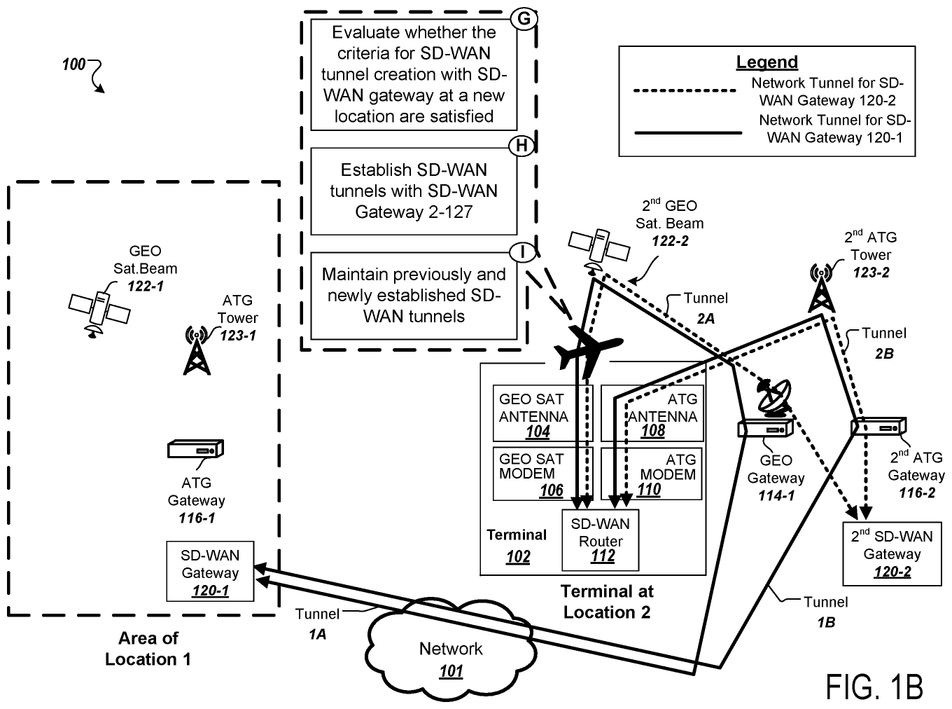

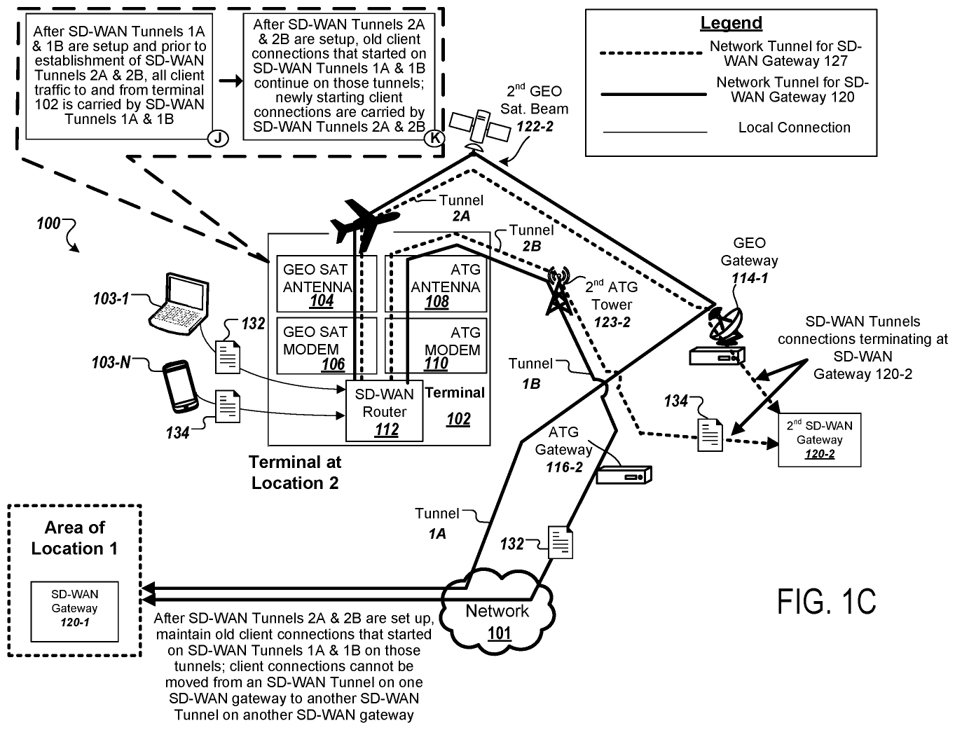

FIG. 1A is a diagram that shows an example of a system 100 for dynamically selecting a software-defined wide area network (SD-WAN) gateway and managing SD-WAN tunnels in a wireless communication network. In the example of system 100, multiple broadband transports can be used in combination to provide an optimized mobile connectivity service with an improved performance, reliability, and availability from what can be provided by either transport alone. For instance, the example of system 100 can combine a low-latency, low-throughput transport, such as, a LEO satellite WAN or ATG WAN, with a high-throughput, high-latency GEO satellite WAN and offer a system that takes advantage of the merits of the two hybrid transports and provides a cost-effective and optimized broadband connectivity that is suitable for a wide range of applications, including web browsing, two-party or group conference calls, online gaming, VPN, video streaming, file transfer, etc. The system employs smart traffic classification and intelligent routing techniques where both transports are utilized concurrently in a manner that satisfies the performance requirements of different applications. As such, network traffic from interactive, real-time, or other latency sensitive applications is carried by the low-latency transport, e.g., LEO or ATG, whereas network traffic from bandwidth-intensive applications that are more sensitive to capacity than they are to latency is carried by the high-latency high-throughput transport, e.g., GEO. Latency sensitive applications may include a multiplayer game, an audio and/or video call, chatting with a person or a bot over the Internet, web surfing, real-time communication in a search-and-rescue operation, interactive and immersive augmented reality (AR) or virtual reality (VR), operating a drone remotely, online auction, online betting, or other interactive applications. Applications that are more sensitive to capacity than to latency may include, for example, file upload or download, video streaming, software downloads and updates.

In some implementations, the system 100 may seek to minimize an amount of round-trip latency for latency sensitive applications, such as cloud-based multiplayer gaming, for example. For example, a round trip latency of 100 milliseconds (ms) or lower can be an established round-trip latency requirement to meet a desired system performance. However, such latency requirements can be difficult to fulfil with satellite communication systems in an environment where a terminal moves across different geographic regions.

As mentioned, one way to maintain communications for end-users on the terminal 102 as the terminal 102 travels is to perform satellite or cellular handovers without loss or interruption of service, e.g., modems switching between different gateways as the modem performs a satellite beam or ATG tower handover. Despite technologies available for managing satellite beam or ATG tower handovers, end users may still experience momentary outages and/or an increase in network latency.

Accordingly, the system 100 can provide a low-latency and high-throughput network service in mobile environments. In particular, the system 100 can utilize the high-throughput aspects of GEO transports and the low-latency aspects of LEO and ATG transports with SD-WAN tunnels to provide an optimized network solution that is suitable to both latency and capacity sensitive client applications. The system 100 can recognize the latency and capacity requirements of end user applications on the terminal 102 and select a communication medium, e.g., WAN transport, that satisfies such requirements. In this manner, the system utilizes a mechanism that routes packets from end user application via the appropriate WAN transport.

The system 100 can include a mobile terminal which supports at least two WAN transports and one or more peer Point of Presence(s) (POP) that provide(s) connectivity to the public Internet. PoP is also referred to as SD-WAN gateway in this specification. The terminal can establish and maintain communication tunnels with an SD-WAN gateway via its WAN transports. For example, the system packages a client data packet in an SD-WAN transport protocol packet, which encapsulates the client packet together with a header information. The system uses the communication tunnels to securely transport end-user data. The header information that is included with a client data packet in an SD-WAN transport protocol packet can convey messages that are important for flow management and statistics gathering.

The example of FIG. 1A illustrates a satellite communication network, but the techniques described here can be used in other communication networks, such as wireless communication networks. FIG. 1A illustrates various operations in stages (A) through (F), which can be performed in the sequence indicated, in another sequence, with fewer stages, or with more stages.

The system 100 includes a terminal 102 that can communicate with various satellites, gateways, and cellular towers as the terminal 102 travels across various geographic locations. For example, in system 100, terminal 102 travels from one geographic location 1 to another geographic location 2, such as domestic travel and/or international travel. The satellites, the gateways, and the cellular towers (along with other network components), can cooperate to transport terminal 102 data in a bidirectional manner over the satellite communication network.

In some implementations, the system 100 illustrates the terminal 102 utilizing various LEO satellites, GEO satellites, and ATG cellular towers, along with SD-WANs to provide a reliable, optimized, and cost-effective broadband connectivity. For example, the system 100 illustrates terminal 102 communicating with GEO satellite beams 122-1 and 122-2, ATG towers 123-1 and 123-2, and their respective wireless gateways, e.g., GEO gateway 114-1, ATG gateway 116-1, and LEO gateway. The terminal 102 can also utilize LEO transport as an additional low-latency transport or as a replacement of ATG transport. Therefore, system 100 where terminal 102 utilizes a LEO transport can include LEO satellites, LEO gateways, other GEO satellites and GEO gateways, as well as other ATG cellular towers, and ATG gateways. This process will be further described below.

In some implementations, the system 100 can include one or more terminals, including terminal 102, that can be configured to provide broadband connectivity to client devices on-board a vehicle. The terminal 102 can be a device or system included on a vehicle, such as an airplane, a boat, a car, a train, or another type of vehicle that is mobile and/or stationary. The vehicle can include one or more client devices that are connected on the Local Area Network (LAN) of terminal 102 with a wired, wireless, e.g., WiFi, Bluetooth, or other LAN connectivity technology. As the vehicle travels to various geographic locations, the terminal 102 can continue to provide broadband connectivity to its client devices using the components shown in system 100. The client devices can include, for example, hand-held devices, telephones, laptop computers, desktop computers, Internet of Things (IoT) devices, and other types of client devices.

Generally, the components on the terminal 102 enable client devices to communicate with and request for data on external networks, while the terminal 102 can be used in a stationary setting or in a mobile environment, e.g., traveling to different geographic locations. Each terminal can support requests from one or more on-board client devices. For example, the client devices can communicate with the one or more components on the terminal 102 to request for and receive data from third party networks, such as the Internet. As will be described below, the one or more components on the terminal 102 can include one or more antennae, one or more WiFi access points, modems, and an SD-WAN router, to name some examples.

The client devices can communicate with an SD-WAN router 112 on the terminal 102 over a network, such as a local area network (LAN). In some examples, a client device can forward or transmit an upstream packet, which has a host in the Internet as its final destination, to the SD-WAN router, and the SD-WAN router can package the device's packet as an SD-WAN transport protocol packet and transmit the packet via one of its WAN transports. A WAN transport modem that receives the SD-WAN protocol packet can convert the digital information into analog using a modulator and transmit the converted analog information to a satellite or ATG tower via the corresponding antenna. The receiving satellite or ATG tower can eventually forward the data to a ground station or backhaul station, respectively, which is then forwarded to a respective wireless gateway. The wireless gateway, then, forwards the SD-WAN transport protocol packet to the SD-WAN gateway through the public Internet. The SD-WAN gateway unpacks the SD-WAN transport protocol packet and retrieves the original remote device packet. The SD-WAN gateway, then, forwards the remote device packet to the ultimate destination through the public Internet. A reply packet from the host in the public Internet takes the reverse path, e.g., the downstream direction, going through SD-WAN gateway, wireless gateway, satellite/ATG tower, modem, SD-WAN router, and finally to the client device in the LAN.

In some implementations, the terminal 102 can include the one or more components that enable transmission and reception in system 100. The SD-WAN router 112 on the terminal 102 can transmit and receive data for a particular client device over a particular communication medium. The SD-WAN router 112 can receive data from one or more client devices on the terminal and determine which WAN transport carries the upstream data to the SD-WAN gateway. Similarly, the SD-WAN gateway decides which WAN transport carries return data to the remote device.

The SD-WAN router 112 or the associated SD-WAN gateway can select the communication medium, e.g., WAN transport, to carry client data based on a policy. The policy can include, for example, evaluating the cost, latency, jitter, packet loss, and capacity of one or more communication mediums, e.g., WAN transports, determining the priority level of the client's received data, recognizing the performance requirements of the application that generated the client's received data, e.g., latency requirements, throughput requirements, and others, to name some examples, and finally selecting the communication medium, e.g., WAN transport, that is best suited to carry the client data. In response, the SD-WAN router 112 or its corresponding SD-WAN gateway can transmit the client's data over the selected communication medium, e.g., WAN transport.

The terminal 102 can include a GEO transport that enables the SD-WAN router 112 and its associated SD-WAN gateway to transmit data via the GEO satellite beam 122-1 over the GEO satellite antenna 104 using the GEO satellite modem 106. In some examples, the terminal 102 can include an ATG transport that enables the SD-WAN router 112 and its associated SD-WAN gateway to transmit data via the ATG tower 123-1 over the ATG antenna 108 using the ATG modem 110. In some examples, the terminal 102 can include a LEO transport that enables the SD-WAN router 112 and its associated SD-WAN gateway to transmit data via a LEO satellite over a LEO satellite antenna using a LEO satellite modem. The ATG modem can use technologies such as 4G, LTE, and 5G in its communication with an ATG tower. In some examples, system 100 can include a LEO transport in a GEO+LEO WAN transport combination, e.g., two WAN transports, or in a GEO+LEO+ATG WAN combination, e.g., three WAN transports System 100 can also have a different combination of the WAN transports.

In this manner, the SD-WAN router 112 can select from one or more of the communication mediums in the hybrid network, e.g., LEO, GEO, and ATG, to transmit and receive data from a particular client device. In some implementations, the SD-WAN router 112 can operate with any combination of WAN transports, where the SD-WAN router 112 can use a GEO+ATG or GEO+LEO WAN combination to provide a high-throughput and low-latency broadband connectivity. As illustrated in the example of system 100 in FIG. 1, the SD-WAN router 112 in terminal 102 operates with GEO+ATG WAN transport combination and has established SD-WAN tunnels with the SD-WAN gateway 120-1.

In some implementations, the SD-WAN gateway 120-1 can be a component of a data center. The data center can include one or more components that communicate with external networks or external third parties, such as the Internet. The data center can include one or more servers or one or more computers, and can communicate with various third party systems or other systems that communicate with the Internet. In some examples, the data center can include one or more SD-WAN gateways that service terminals in the system 100. In the example of system 100, the SD-WAN gateway 120-1 at the data center can communicate with terminals through one or more wireless gateways on the ground.

Generally, and as will be further described below, the terminal 102 can communicate with the SD-WAN gateway 120-1 at a particular data center through the one or more of its WAN transports. Similarly, the SD-WAN gateway 120-1 can communicate with the terminal 102 and service other terminals in system 100 through the one or more wireless gateways over the particular communication medium. The one or more wireless gateways can include, for example, one or more LEO gateways, one or more ATG gateways, and one or more GEO gateways. In this manner, the SD-WAN gateway 120-1 can anchor user connections from a terminal, e.g., terminal 102, for communicating with hosts, devices, systems, and other networks over the Internet. An SD-WAN gateway is an anchor point for a client connection that communicates with a host in the public Internet because return traffic from the Internet host is routed back to the same SD-WAN gateway.

In some implementations, the system 100 can include multiple data centers located in various geographic regions around the globe. Each of these data centers, which houses one or more SD-WAN gateways, can send and receive SD-WAN transport protocol packets to and from one or more wireless gateways through the public Internet. The one or more wireless gateways serve as anchor points for the terminal SD-WAN connections that go to the one or more SD-WAN gateways. Serving as anchor points for the terminal enables the wireless gateways to facilitate communication for the terminal SD-WAN connections to the one or more SD-WAN gateways. As illustrated in system 100, the SD-WAN gateway 120-1 can send and receive data, e.g., SD-WAN transport protocol packets, to and from a GEO gateway 114-1 and an ATG gateway 116-1.

In some implementations, the GEO gateway 114-1 can serve as the anchor point for terminal 102 connections that are carried by the GEO modem 106. GEO gateway 114-1 can be the anchor point for terminal 102 connections carried by the GEO communication medium because downstream connections that go to terminal 102 via the GEO transport are routed back to GEO gateway 114-1. Specifically, the GEO gateway 114-1 can communicate with the terminal 102 using the GEO communication medium. In further detail, the GEO gateway 114-1 can communicate with the GEO satellite modem 106 on the terminal 102 through the GEO satellite beam 122-1 and the GEO satellite antenna 104. In some examples, when a client device on the terminal 102 forwards or transmits an upstream packet to the SD-WAN router 112 on the terminal 102, the SD-WAN router 112 can package the client packet as an SD-WAN transport protocol packet and transmits their via the GEO transport.

An SD-WAN transport protocol packet to be transmitted via the GEO transport is received by the GEO modem 106, which then transmits the packet through the GEO satellite antenna 104 to GEO gateway 114-1 via the GEO satellite beam 122-1. Return traffic to SD-WAN router 112 goes through the same path but in the reverse direction.

In some implementations, the ATG gateway 116-1 can serve as the anchor point for terminal 102 connections that are carried by that the ATG transport. ATG gateway 116-1 can be the anchor point for terminal 102 connections carried by the ATG communication medium because downstream connections that go to terminal 102 via the ATG transport are routed back to ATG gateway 116-1. In further detail, the ATG gateway 116-1 can communicate with the ATG modem 110 on the terminal 102 through the ATG tower 123-1 and the ATG antenna 108. In some examples, when a client device on the terminal 102 forwards an upstream packet to the SD-WAN router 112 on the terminal 102, the SD-WAN router 112 can package the client packet as an SD-WAN transport protocol packet and transmits it via the ATG transport.

An SD-WAN transport protocol packet to be transmitted via the ATG transport is received by the ATG modem 110, which then transmits the packet through the ATG antenna 108 to ATG gateway 116-1 via the ATG tower 123-1. Return traffic to SD-WAN router 112 goes through the same path but in the reverse direction. In some examples, the ATG gateway 116-1 that the ATG modem 110 is currently associated with and a respective ATG tower, e.g., ATG tower 123, can communicate using a GPRS tunneling protocol (GTP).

In some implementations, the LEO gateway can serve as the anchor point for terminal 102 connections that are carried by that the LEO transport. LEO gateway can be the anchor point for terminal 102 connections carried by the LEO communication medium because downstream connections that go to terminal 102 via the LEO transport are routed back to the same LEO gateway. In further detail, the LEO gateway can communicate with the LEO satellite modem on the terminal 102 through the LEO satellite and the LEO satellite antenna. In some examples, when a client device on the terminal 102 forwards an upstream packet to the SD-WAN router 112 on the terminal 102, the SD-WAN router 112 can package the client packet as an SD-WAN transport protocol packet and transmits it via the LEO transport.

An SD-WAN transport protocol packet to be transmitted via the LEO transport is received by the LEO modem, which then transmits the packet through the LEO satellite antenna to the LEO gateway via the LEO satellite. Return traffic to SD-WAN router 112 goes through the same path but in the reverse direction.

In some implementations, each of the communication mediums can include a respective modem. In some examples, the GEO communication medium on terminal 102 can include a GEO satellite modem 106. Similarly, the terminal 102 can include an ATG modem 110 and a LEO modem for the ATG communication medium and the LEO communication medium, respectively.

A modem can include one or more hardware components, e.g., computer components, which enables the SD-WAN router 112 to connect to and communicate with an external device or network, e.g., the SD-WAN gateway 120-1 or the Internet. In some examples, each of the modems can convert a digital signal received from the SD-WAN router 112 into its corresponding analog components and used for transmission. In some examples, each of the modems can convert an analog signal received from an antenna to digital data that the SD-WAN router 112 can understand.

In some implementations, each of the communication mediums can include a respective antenna. In some examples, the GEO communication medium on terminal 102 can include a GEO satellite antenna 104. Similarly, the terminal 102 can include an ATG antenna 108 and a LEO satellite antenna, respectively. An antenna can include one or more hardware components that is configured to convert electrical signals into radio waves, and transmit the radio waves to external devices.

As illustrated in system 100, the GEO satellite antenna 104 can convert the electrical signals received from the GEO satellite modem 106 into radio waves. In response, the GEO satellite antenna 104 can transmit the radio waves to the GEO satellite, which are demodulated as digital data in the ground station and subsequently propagated to the GEO gateway 114-1. Similarly, the ATG antenna 108 can convert the electrical signals received from the ATG modem 110 into radio waves.

In response, the ATG antenna 108 can transmit the radio waves to the ATG tower 123-1, which are demodulated as digital data and are subsequently propagated to the ATG gateway 116-1 via the backhaul transport. Data transmission process of the LEO transport is like that of the GEO in many aspects. The LEO satellite antenna can convert the electrical signals received from the LEO satellite modem into radio waves. The LEO satellite antenna then transmits the radio waves to the LEO satellite, which are demodulated as digital data in the ground station and subsequently propagated to a LEO gateway.

In some implementations, the terminal 102 can establish a communication tunnel to securely transport client data along with header information, e.g., metadata, to an SD-WAN gateway. The header information that is carried along with the client data packet can covey messages that are important for flow management and statistics gathering, for example. The communication tunnel, which is also called SD-WAN tunnel, can be, for example, a VPN tunnel, or another type of tunnel. In some examples, the SD-WAN tunnel can be encapsulated inside a standard tunnel, such as an Internet Protocol Security (IPSec) tunnel. The SD-WAN router 112 can establish a SD-WAN tunnel with a particular SD-WAN gateway to send and receive SD-WAN transport protocol packets to and from the SD-WAN gateway securely across unsecure underlay transports. For example, the SD-WAN router 112 can initiate setting up of an SD-WAN tunnel with an SD-WAN gateway by negotiating security parameters, such as encryption/decryption keys, lifetime keys, encryption/decryption algorithms, and message authentication algorithms, etc. Once the SD-WAN router 112 and the SD-WAN gateway have validated each other's security parameters, then the SD-WAN tunnel is established between the devices over the underlay transport, which can be a GEO, LEO or ATG transport. For example, as illustrated in the example of system 100, the terminal 102 can establish an SD-WAN tunnel 1A over the GEO transport and an SD-WAN tunnel 1B over the ATG transport.

The SD-WAN tunnel can be established using, for example, Datagram Transport Layer Security (DTLS), IPsec, or other types of tunneling protocols. The protocols of the SD-WAN tunnel can encapsulate the data packets being transmitted and can ensure secure delivery of the data packets to the recipient. DTLS is a communication protocol that provides security to datagram-based applications and utilizes the User Datagram Protocol (UDP).

In some implementations, the terminal 102 can establish multiple communication tunnels with an SD-WAN gateway. In some examples, the SD-WAN router 112 can establish an SD-WAN tunnel 1A to SD-WAN gateway 120-1 through the GEO transport and the SD-WAN router 112 can establish another SD-WAN tunnel 1B to SD-WAN gateway 120-1 through the ATG transport. In this manner, the SD-WAN router 112 can carry data from a client device over a selected SD-WAN tunnel. Additionally, the SD-WAN router 112 can establish another SD-WAN tunnel to the SD-WAN gateway 120-1 through the LEO transport. In these examples, the SD-WAN router 112 can select from one of the three SD-WAN tunnels to transmit client data.

Once the SD-WAN router 112 has initiated an upstream client connection over a particular SD-WAN tunnel that is established with a given SD-WAN gateway 120-1, the SD-WAN router 112 may later switch the client's connection over to another SD-WAN tunnel established with the same SD-WAN gateway 120-1 depending on conditions, such as change in the availability or performance of the WAN transports supporting the SD-WAN tunnels or change in the priority level assigned to the client connection. Similarly, a SD-WAN gateway 120-1 that has initiated a downstream client connection over one SD-WAN tunnel may later switch the downstream connection over to another SD-WAN tunnel depending on conditions, such as the ones mentioned above.

However, a client's upstream or downstream connection that is carried on any of the SD-WAN tunnels established between SD-WAN router 112 and SD-WAN gateway 120-1 are limited to the SD-WAN tunnels established between the two devices. As such, an upstream client connection on SD-WAN router 120-1 cannot be switched from an SD-WAN tunnel established with SD-WAN gateway 120-1 to another SD-WAN tunnel that is established with SD-WAN gateway 120-2.

In some examples, as illustrated in FIG. 1A, the SD-WAN router 112 can establish an SD-WAN tunnel 1A through the GEO satellite modem 106, the GEO satellite antenna 104, the GEO satellite beam 122-1, the GEO gateway 114-1, and to the SD-WAN gateway 120-1. In some examples, the SD-WAN router 112 can establish an SD-WAN tunnel 1B through the ATG modem 110, the ATG antenna 108, the ATG tower 123-1, the ATG gateway 116-1, and to the SD-WAN gateway 120-1. Similarly, the SD-WAN router 112 can establish an SD-WAN tunnel through the LEO satellite modem, the LEO satellite antenna, the LEO satellite, the LEO gateway, and to the SD-WAN gateway 120-1.

In some implementations, the SD-WAN router 112 can establish an SD-WAN tunnel with an SD-WAN gateway 120-1 on a per class-of-service (COS) per WAN transport basis. Moreover, the terminal 102 can support dynamic Quality-Of-Service (QOS) over WAN transports by using a SD-WAN transport protocol that encapsulates a client's data packet along with header information (metadata). The header information that goes along with the client data packet conveys vital information, including connection identification, stream identification and sequence number. The SD-WAN transport protocol is a UDP based protocol. The encapsulated client packet and the header that goes along with it make up a SD-WAN packet. The QOS priority that applies to a client's packet is embedded in the stream identification field of the SD-WAN packet header. The sequence number of SD-WAN packet is useful in reordering of packets that were received out-of-sequence by SD-WAN router 112 or SD-WAN gateway 120-1. The sequence number is also useful in detecting packet drops and measuring the packet loss rate over a WAN transport.

As illustrated in system 100, the terminal 102 travels between different geographic locations. In some examples, terminal 102, which may be located on an aircraft, travels from a location 1 to location 2 (from San Diego, California to Washington, D.C., or from Washington, D.C. to London, United Kingdom, for example). Similarly, the terminal 102 may be located on a boat or in another type of vehicle. In this manner, the terminal 102 can change geographic locations as the vehicle that carries the terminal travels.

In some implementations, as the terminal 102 travels, the terminal 102 maintains the SD-WAN tunnels it established with an SD-WAN gateway to provide uninterrupted broadband connectivity service to its on-board client devices.

As illustrated in system 100, while the terminal 102 is located at location 1, the ATG modem 110 is associated, e.g., established connection, with the ATG gateway 116-1 through the ATG tower 123-1. Similarly, while the terminal 102 is located at location 1, the GEO satellite modem 106 associated with the GEO gateway 114-1 through the GEO satellite beam 122-1. A LEO satellite modem can also be associated with a LEO gateway through a LEO satellite. In some examples, the modems can associate with a particular wireless gateway by establishing a connection with the particular wireless gateway.

In some implementations, a distance between the antenna on the terminal 102 and a satellite or cellular tower varies according to the type of communication medium. In some examples, the distance between the ATG antenna 108 on the terminal 102 and the ATG tower 123-1 may be less than 130 miles. As an example, the distance between the LEO satellite antenna on the terminal 102 and the LEO satellite may be less than 1,200 miles. As an example, the distance between the GEO satellite antenna 104 on the terminal 102 and the GEO satellite may be more than 22,000 miles. The aforementioned distances between each of the antennae and their respective satellite or cellular towers are examples and other distances are also possible.

In some implementations, each of the satellites and cellular towers can provide signals for the modems through the respective antennae on the terminal 102. For example, a satellite may provide spot beams, which are satellite signals that are specifically concentrated in power over a particular geographic area on the Earth. Typically, only a designated intended reception area can properly receive the spot beam. Moreover, satellites can transmit various spot beams that have different data signals using the same frequency.

Satellites can typically use a limited number of frequencies designated by their physical characteristics and/or hardware tuning. Accordingly, the ability of a satellite to re-use a frequency for different geographic locations provides network coverage for an overall large geographical area with a limited frequency spectrum as the same frequency can be used in several regions. For example, a LEO satellite can transmit two spot beams at 19.5 GHz to two different regions on the Earth. Similar functionality is also present in cellular communication where a cellular tower can use the same radio frequency with two or more cells.

The coverage area of wireless communication systems can vary depending on the signal power and the distance between transmitter and receiver. In some examples, the radius of the coverage area from an ATG tower can range from 100 to 180 miles. In some examples, spot beam from a LEO satellite can cover an area of 405,407 miles². In some examples, a spot beam from a GEO satellite can cover an area of 421.6 million miles². The above coverage areas are examples, and other coverage areas are also possible.

Accordingly, as the terminal 102 travels across different geographic locations, a terminal 102's modem maintains connectivity with satellite/satellite-beam or ATG tower if terminal 102 remains within the coverage area of the satellite/satellite-beam or ATG tower. Typically, terminal 102's modem remains associated with the same wireless gateway if the modem maintains its connectivity to its satellite/satellite-beam or ATG tower. For example, at location 1, the ATG modem 110 of terminal 102 is associated to the ATG gateway 116-1 via ATG tower 123-1. As the terminal 102 moves away from location 1, the ATG modem 110 may leave the coverage area of ATG tower 123-1.

Accordingly, the ATG modem 110 may attach to a new ATG tower 116-2 when terminal 102 has entered the coverage area of the new ATG tower. In some examples, ATG modem 110 may perform an ATG tower handover when the strength of the signal from the previous tower is weak and that from the new tower is stronger. ATG modem may switch its association to a different ATG gateway when it has performed an ATG tower handover. For example, as illustrated in system 100, the ATG modem 110 of terminal 102 can switch to ATG gateway 116-2 when the terminal 102 moves out of ATG tower 123-1's coverage area and into ATG tower 116-2's coverage area.

In some implementations, gateway switchover may occur more frequently with ATG modems than with the GEO or LEO modems. Typically, a GEO satellite has a wider coverage area than a LEO satellite, and a LEO satellite has a wider coverage area than ATG cellular tower. Accordingly, the terminal 102 can travel longer distances and remain within a single GEO or LEO satellite signal coverage area than with an ATG tower. Moreover, GEO satellites can provide connectivity to a vast geographical area but operate with an order of magnitude higher in latency than LEO or ATG satellites.

The GEO modem 106 may perform a GEO gateway switchover as the terminal 102 leaves one GEO satellite spot-beam and enters another or moves from one satellite coverage area into another GEO satellite. In some examples, the GEO satellite modem 106 may perform gateway switchover when the terminal 102 moves out of beam coverage of GEO satellite beam 122-1 and into beam coverage of GEO satellite 122-2. In this example, the GEO satellite modem 106 can switch from GEO gateway 114-1 to GEO gateway 114-2 when terminal 102 moves out of beam coverage of GEO satellite beam 122-1 and into beam coverage of GEO satellite beam 122-2. In some examples, the LEO satellite modem on the terminal 102 may switch from one LEO gateway to another LEO gateway when the terminal 102 leaves one LEO spot-beam and enters another LEO spot-beam or moves from one LEO satellite coverage area to another LEO satellite's coverage area. In these examples, an ATG modem may perform more ATG gateway switchovers than GEO satellite modem 106 or LEO modem because ATG tower has a smaller coverage area than a GEO or LEO. Terminal 102 modems may not perform wireless gateway switchover all at the same time or all at the same place. Sometimes, ATG modem may perform two or more ATG gateway switchover before GEO modem does a single GEO gateway switchover.

In some implementations, the modems of terminal 102 may switch between different gateways for reasons other than beam coverage. For example, a wireless gateway can instruct a modem of terminal 102 to switch to using another wireless gateway when the wireless gateway is undergoing a shutdown. Additionally, the LEO/GEO modem of terminal 102 can receive periodic gateway loading status messages from a pool of wireless gateways it is configured to work with. The modem may decide to switch to a new wireless gateway with less load when it has evaluated the current loading status of its pool of wireless gateways and determines that the wireless gateway it is currently working with has become overloaded. For example, a GEO satellite modem 106 may switch from a GEO gateway 114-1 to another GEO gateway within the same spot-beam coverage of the GEO satellite beam 122-1 when GEO gateway 114-1 becomes unavailable or when the GEO gateway 114-1 is overloaded and another gateway 114 with less load is available. An overloaded wireless gateway may become a performance bottleneck for terminal 102. A similar gateway switchover can occur for the LEO satellite modem and LEO gateways.

During stage (A), a vehicle, such as an aircraft, can initiate travel from location 1 to location 2. The vehicle can be carrying multiple devices, including the terminal 102, one or more client devices, and other components. For example, the aircraft that carries the terminal 102 can travel from location 1 to location 2. In some implementations, the locations 1 and 2 may simply represent different points along a path of travel, and thus may not represent the origin and destination for a trip. The techniques shown for FIGS. 1A-1C can be repeated multiple times during travel, including evaluating and potentially changing gateway selection (as well as potentially establishing new network tunnels) at three, four, five, or more different locations during travel.

As illustrated in FIG. 1A, at location 1, the ATG modem 110 can establish association or a connection with the ATG gateway 116-1. The reason that the ATG modem 110 associates with the ATG gateway 116-1 can be because the mobility management entity of the ATG system has identified the wireless gateway to be the closest to the modem when ATG modem 110 attached to ATG tower 123-1. The ATG gateway serves as the anchor point for data connections from the terminal 102 to hosts in the public Internet. As such, ATG modem 110 of the terminal 102 is allocated an IPV4 or IPV6 address from the ATG gateway that is associated to ATG modem 110, which is ATG gateway 116-1 in this case.

ATG modem 110 may retain its connection to the same ATG gateway even though movement of terminal 102 might have caused a handoff from one ATG tower to the next. This approach enables maintenance of persistent connections for user client devices behind the ATG modem 110, e.g., terminal 102 in system 100, to hosts outside of the ATG network, e.g., SD-WAN gateway 120-1 in system 100. However, the use of the same ATG gateway as an anchor point for ATG modem 110 may result in increased latency when terminal 102 has travelled long distance, e.g., a distance greater than a threshold, since ATG modem 110 first established connection with the ATG gateway.

In some implementations, the mobility management entity of the ATG system may select a new ATG gateway when movement of terminal 102 has caused a handoff to a new ATG tower and the new ATG gateway is the closest to the ATG tower's service area. This approach simplifies mobility management and allows the use of an ATG gateway to provide the lowest latency connection to the public Internet.

Similarly, the GEO satellite modem 106 can establish a connection with the GEO gateway 114-1 when the modem enters a satellite beam 122-1 beam coverage area that is served by the gateway 114-1. Selection of a GEO gateway may be dependent upon the configuration and/or the logic in the GEO satellite modem or a mobility management entity. In some implementations, a similar gateway selection and connection establishment process may be employed in a LEO system when terminal 102 is using a LEO transport for broadband connectivity.

In some implementations, the SD-WAN router 112 can establish communication with the SD-WAN gateway 120-1 using the established connections between the one or more modems on the terminal 102 and the one or more corresponding wireless gateways on the ground. In further detail, the SD-WAN router 112 can establish one or more SD-WAN tunnels with the SD-WAN gateway 120-1. An SD-WAN tunnel is a UDP/IP based connection from SD-WAN router 112 to SD-WAN gateway 120-1. SD-WAN tunnel connection established between SD-WAN router 112 and SD-WAN gateway 120-1 over a wireless transport, e.g., GEO, LEO or ATG, is resilient and can survive a wireless gateway switchover event which may result in IP address change on the WAN transport. SD-WAN packets that are exchanged between SD-WAN router 112 and SD-WAN Gateway 120-1 can include connection identification information in the header. The connection identification information allows SD-WAN Gateway 120-1 to maintain the state of its connection to SD-WAN router 112 even though the ATG gateway switchover might have resulted in change of IP address on terminal 102's ATG transport. SD-WAN router 112 sends periodic keep alive messages to SD-WAN gateway 120-1 on each of the SD-WAN tunnel connections, which allows keeping Network Address Translation (NAT) sessions alive on NAT performing devices on the path from SD-WAN router to SD-WAN gateway 120-1. The SD-WAN gateway 120-1 updates the SD-WAN tunnel endpoint information when it detects IP address change on SD-WAN router 112's transport corresponding to the SD-WAN tunnel.

In some examples, the SD-WAN router 112 can establish an SD-WAN tunnel 1A that originates at the SD-WAN router 112, traverses through the GEO satellite modem 106, the GEO satellite antenna 104, the GEO satellite beam 122-1, the GEO gateway 114-1, and terminates at the SD-WAN gateway 120-1.

The SD-WAN tunnel 1A enables the SD-WAN router 112 and SD-WAN gateway 120-1 to exchange client data securely.

In some examples, the SD-WAN router 112 can establish an SD-WAN tunnel 1B that originates at the SD-WAN router 112, traverses through the ATG modem 110, the ATG antenna 108, the ATG tower 123-1, the ATG gateway 116-1, and terminates at the SD-WAN gateway 120-1. The SD-WAN tunnel 1B enables the SD-WAN router 112 to transmit client data to the SD-WAN gateway 120-1 and receive responses from the SD-WAN gateway 120-1 in a secure manner.

In some cases, the SD-WAN router 112 can configure the SD-WAN tunnel 1A and SD-WAN tunnel 1B for different purposes. For example, the SD-WAN router 112 or its peer SD-WAN gateway 120-1 can transmit data from a first application on a first client device over SD-WAN tunnel 1A and data from another application on a second client device over SD-WAN tunnel 1B. The SD-WAN router 112 can transmit client data on a particular SD-WAN tunnel according to the characteristics of the transport and the performance requirement of the application.

In some examples, the SD-WAN router 112 can schedule client data that requires lower latency, e.g., faster responses, to be transmitted over SD-WAN tunnel 1B because of the ATG's communication medium has lower latency. In some examples, the SD-WAN router 112 can schedule client data that requires higher throughput to be transmitted over SD-WAN tunnel 1A because of the higher channel capacity on the GEO communication medium.

During stage (B) in the example of FIG. 1A, the terminal 102 monitors each of the modems to detect a wireless gateway change as the terminal 102 moves. In some implementations, a modem of the terminal 102 connects to a wireless gateway that is geographically closest to the current location of the modem.

In some implementations, the modem can perform gateway switchover as the terminal moves and performs an ATG tower or a satellite beam handoff. In further detail, as the modem of the terminal moves between spot beams, the modem can perform gateway switchover. A modem of the terminal can perform wireless gateway switchover not only because of ATG tower or satellite spot beam handoff but also because of other reasons. These other reasons can include, for example, load-balancing of traffic among the gateways is needed or because a currently serving gateway is undergoing maintenance.

In some implementations, the terminal 102 can utilize different techniques in detecting when a wireless gateway switchover has happened. In some examples, one or more processors, separate from the SD-WAN router 112 can monitor each of the modems on the terminal 102 to determine whether a gateway switchover has occurred.

In some implementations, the terminal 102 can perform a variety of processes to determine whether a modem has performed a gateway switchover. The terminal 102 can monitor hardware and software components on the modem to determine whether the gateway switchover occurred. In some examples, the terminal 102 can periodically poll a software component in each of the modems using an application program interface (API) call or another method to fetch information about the wireless gateway that the modem is currently associated with. The wireless gateway information can include the gateway's unique identifier, the geolocation of the wireless gateway, e.g., latitude and longitude information, a residential or commercial address of the connected wireless gateway, and other information.

In some cases, terminal 102 can determine that its modem has likely performed a wireless gateway switchover when the dynamic IP address assigned to the terminal's WAN interface by the modem has changed. In this case, the IP address that the modem assigns to terminal 102's WAN interface is allocated by the wireless gateway at the time of the modem's association to the wireless gateway.

In some cases, system 100 can determine that terminal 102's modem has likely switched to a wireless gateway when detecting change in the source IP address of the SD-WAN tunnel connections that are carried via that modem.

In some implementations, system 100 may host a dedicated server in the public Internet which serves as Internet Service Provider (ISP) analyzer. The functions of the ISP analyzer server may include ISP resolving, e.g., the name of the ISP, WAN IP reporting, and determination of ISP gateway geographical location. Terminal 102 can send periodic probe requests to the ISP resolver for each of its modems to get information related to the wireless gateway that is associated to a particular modem. The ISP resolver responds with the WAN IP, gateway geographical location, and other ISP details in its reply message to the probe request. Terminal 102 can determine whether its modem has switched its association to a wireless gateway by evaluating WAN IP and other related information that it obtains from the ISP resolver server in the server's response message to the terminal's ISP probe request.

When a modem of the terminal 102 connects to a particular wireless gateway, e.g., ATG modem 110 connects to ATG gateway 116-1, the modem can obtain location information of the connected wireless gateway using different methods.

During stage (C) in the example of FIG. 1A, the vehicle on which the terminal 102 resides can travel from location 1 to location 2. In some examples, the vehicle may be an aircraft, which flies from one location to another. In some examples, the vehicle may be a boat, which sails from one location to another location. Other examples are also possible.

In the example of system 100, the vehicle in which the terminal 102 resides can continue to move and change locations, such as from location 1 to a location 2. As the vehicle travels, the radio signal transmitted by ATG Tower 123-2 may fail to reach or become severely degraded at the new location. If this is the case, the ATG modem 110 can perform handover to another ATG tower which has signal coverage at the new location. A similar process can apply in a GEO or LEO satellite communication system where a GEO or LEO modem performs a satellite or satellite beam handover when movement of terminal 102 causes the respective modem to go out of the original satellite or satellite beam and into a new satellite or satellite beam.

During stage (D) in the example of FIG. 1A, as the vehicle travels from location 1 to location 2, the terminal 102 may move out of the coverage area of the satellites beam and/or the ATG tower at location 1. In some examples, signal transmitted from the ATG tower 123-1 cannot reach the location of the terminal 102 while terminal 102 is at location 2. However, the transmitted signal from the GEO satellite beam 122-1 can reach the location of the terminal 102 while at location 2. In some examples, signal from the ATG tower 123-1 can reach the location of the terminal 102 while at location 2 while signal from the GEO satellite beam 122-1 cannot reach the location of the terminal 102. In some examples, signal from the LEO satellite at location 1 may reach the location of the terminal 102 while at location 2. Other example configurations are also possible.

In an example where a transmitted signal from a satellite beam or an ATG tower at location 1 does not reach terminal 102's GEO/LEO or ATG modem when the terminal 102 is at location 2, the respective modem of terminal 102 or a mobility management entity may trigger a handoff to another satellite beam or ATG tower which covers location 2 with better signal strength. As illustrated in the example of system 100, the ATG modem 110 can connect to ATG Tower 123-2 when terminal 102 is at location 2. In this example, the signal of the ATG tower 123-1 is either unreachable or has weak strength when the terminal 102 is at location 2. On the other hand, the signal transmitted by ATG tower 123-2 covers location 2 with adequate signal strength.

Here, the ATG antenna 108 can receive the transmitted signal from the ATG tower 123-2. The ATG antenna 108 can forward the received signal to the ATG modem 110 in electronic form. The ATG modem 110 may associate with a new wireless gateway when it has performed a satellite beam or ATG tower handoff at location 2. As illustrated in system 100, the ATG modem 110 can establish a new connection with the ATG gateway 116-2 through the ATG Tower 123-2 when terminal 102 is at location 2.

In some implementations, the ATG modem 110 can connect to the ATG gateway 116-2 through the ATG Tower 123-2 because ATG gateway 116-2 is the closest gateway that serves ATG towers in location 2. In some implementations, the connection from ATG tower 123-2 to ATG gateway 116-2 may be based on GPRS Tunneling Protocol (GTP) or some other protocol.

In some implementations, a GEO or LEO modem may associate to a new GEO or LEO gateway when the modem has performed a satellite or a satellite beam handover at location 2. The implementation may employ different gateway selection mechanisms when a GEO/LEO modem has performed a handover to a new satellite or satellite beam. One such mechanism may select a GEO or LEO gateway from the pool of GEO/LEO gateways serving the satellite or satellite beam based on one or a combination of configuration, gateway load status, the need to maintain client's persistent connections, or the need to provide the lowest latency path.

During stage (E) in the example of FIG. 1A, the terminal 102 can detect a modem has connected to a new wireless gateway. The terminal 102 can detect the modem, such as ATG modem 110, has connected to the ATG gateway 116-2 using one or more of the mechanisms mentioned in stage (B). For example, the terminal 102 may detect that the ATG modem 110 has performed a gateway switchover after observing a WAN IP change on the ATG modem or after observing change in identifier of the modem's associated ATG gateway. Terminal 102 can seek to connect to another SD-WAN gateway when it detects that the ATG modem has switched over to a different ATG gateway.

During stage (F) in the example of FIG. 1A, SD-WAN router 112 evaluates whether to establish SD-WAN tunnels with a new SD-WAN gateway when it detects that one of the terminal 102's modems has made a switchover to a new wireless gateway. In some implementations, SD-WAN router 112 may decide to establish SD-WAN tunnels with a new SD-WAN gateway when the new SD-WAN gateway is determined to have the lowest latency, typically through the low-latency transport, e.g., ATG or LEO. In some implementations, the selection of the SD-WAN gateway to connect to may be determined based on different criteria, including geographical proximity of the SD-WAN gateway to the modem's associated wireless gateway, special configuration such as one that maps wireless gateway to SD-WAN gateway, and other criteria. This specification assumes that the SD-WAN gateway location that is the closest to the location of the low-latency modem's associated wireless gateway can provide the lowest latency path from terminal 102 to the public Internet.

In some implementations, terminal 102 may utilize various techniques to identify the SD-WAN gateway that provides the lowest latency path via any of the terminal's WAN transports. These techniques can include exchange of latency probing messages between terminal 102 and any of its candidate SD-WAN gateways. The latency probing messages can be initiated either after temporarily pausing client traffic or significantly reducing the client traffic rate to the degree that the WAN transport that will carry latency probing messages will not be congested. Terminal 102 can initiate latency probing operations to any of its candidate SD-WAN gateways when it has detected that the low-latency WAN modem has performed a wireless gateway switchover.

In some examples, the terminal 102 can send multiple latency probe request messages to each of the SD-WAN gateways. In this example, the terminal 102 can receive a latency probe reply from each SD-WAN gateway in response to the probe request. For each message sent to each SD-WAN gateway, the terminal 102 can compute the latency by measuring the amount of time taken to transmit a probing message and receive a corresponding response, e.g., the round-trip-time (RTT). The terminal 102 evaluates the average RTT for each of the SD-WAN gateways. Then, terminal 102 selects the SD-WAN gateway with the minimum average RTT and establishes SD-WAN tunnels with it. For example, the terminal 102 can select the SD-WAN gateway 120-2 that has the lowest latency average.

In some implementations, terminal 102 may utilize various techniques to identify the SD-WAN gateway that is geographically closest to the wireless gateway that the low-latency WAN modem is associated with. These techniques can include determination of the geolocation information, e.g., latitude and longitude information, of the modem's wireless gateway and any of the candidate SD-WAN gateways.

In some implementations, the geolocation information of SD-WAN gateways can be provided to terminal 102 in the form of configuration parameters or via a special message from a network management system. Each terminal can include a database that stores geographic information for each of the SD-WAN gateways around the world. The database stores data that identifies each of the SD-WAN gateways, geographic location information for each of the SD-WAN gateways, and address information for each of the SD-WAN gateways. For example, the data identifying each of the SD-WAN gateways can include a name of the SD-WAN gateway and data identifying a datacenter that houses the corresponding datacenter. The geographic location information can include, for example, latitude and longitude information identifying a location of the SD-WAN gateway, residential or commercial address of the SD-WAN gateway, and other geographic location information identifying the location of the SD-WAN gateway. The address information can include, for example, an IP Address of the SD-WAN gateway. In some examples, the terminal 102 can receive data identifying the SD-WAN gateways, e.g., including the geolocation information, as configuration parameter from a network management system or network operator. The terminal 102 can store the data in file on persistent storage medium, such as in a flash or hard disk.

In some implementations, each terminal in system 100 can receive a list of data identifying the SD-WAN gateways. Terminal 102, for example, can receive the list of data identifying the SD-WAN gateways over an application programmable interface (API) over the Internet. In some examples, the terminal 102 can receive the list of data identifying the SD-WAN gateways as a configuration parameter from a designer of system 100. The terminal 102 can store the list in its database or memory.

Terminal 102 can find geolocation information of wireless gateways in its configuration parameters, or it can obtain that information from the respective modem using API calls. Terminal 102 can also obtain the geolocation of a wireless gateway by querying its ISP resolver server. The ISP resolver server can maintain IP address or IP address range to geolocation mapping database, hence allowing the IP resolver server to resolve the geolocation of a wireless gateway by searching its database using the WAN IP address that is allocated by the wireless gateway to terminal 102's modem as key. Terminal 102 can also utilize other methods in determining the geolocation information of wireless gateways when the preceding method does not apply. The closest SD-WAN location from the location of the wireless gateway that is associated with terminal 102's modem can be determined by computing the geographical distance using the geolocation information of SD-WAN gateways and the wireless gateway. Ordinarily, the SD-WAN gateway location that is closest to the modem's wireless gateway location can provide the lowest latency path from terminal 102 to the public Internet. In some examples, the closest SD-WAN location from the location of the wireless gateway that is associated with the terminal 102's modem is the lowest latency path.

As illustrated in the example of system 100, location 2 may include a set of SD-WAN gateways. The set of SD-WAN gateways at location 2 can include, for example, SD-WAN gateway 120-2, SD-WAN gateway 120-3, and SD-WAN gateway 123-4. A location in system 100 may include fewer or greater SD-WAN gateways than the number illustrated in FIG. 1A. The terminal 102 can determine a geographical distance between the ATG gateway 116-2 and the SD-WAN gateway 120-2, the ATG gateway 116-2 and the SD-WAN gateway 120-3, and the ATG gateway 116-2 and the SD-WAN gateway 123-4.

As illustrated in the example of FIG. 1A, the terminal 102 can use the geographical distance computation method to determine the distance between the location of ATG gateway 116-2 and the locations of SD-WAN gateways 120-2, 120-3, and 120-4, to be 100 miles, 500 miles, and 1000 miles, respectively. Other distances and number of SD-WAN gateways to compare to the ATG gateway are also possible.

At stage (F) in the example of FIG. 1A, the terminal 102 can select the SD-WAN gateway whose geographical distance is the closest to ATG gateway 116-2. In this example, the terminal 102 compares the geographical distance of each SD-WAN gateway location from the location of ATG gateway 116-2 and select the SD-WAN gateway location whose geographical distance is the shortest. The terminal 102 can select SD-WAN gateway 120-2 because this SD-WAN gateway has the shortest geographical distance, i.e., 100 miles, making the location of that SD-WAN gateway the closest to ATG gateway 116-2 among the three available SD-WAN gateway locations.

In some implementations, the terminal 102 can employ a latency probing technique described earlier to identify an SD-WAN gateway when terminal 102's modem has performed a wireless gateway switchover. The terminal 102 can employ the latency probing technique when the terminal 102 is unable to obtain the geographical information of the modem's newly associated wireless gateway. In the example of system 100, the terminal 102 can employ the latency probing technique to determine an SD-WAN gateway location among the locations of SD-WAN gateways 120-2, 120-3, and 123-4 that has the lowest expected latency from terminal 102 via the new wireless gateway.

FIG. 1B is a diagram that is a continuation of the flow diagram illustrated in FIG. 1A. FIG. 1B illustrates various operations in stages (G) through (I), which can be performed in the sequence indicated, in another sequence, with fewer stages, or with more stages.

In some implementations, terminal 102 can immediately initiate setting up of SD-WAN tunnels with an SD-WAN gateway that is obtained from the SD-WAN gateway location that has been selected as the new closest when the movement of the terminal has caused the terminal's modem to perform a switchover to a new wireless gateway.

In some implementations, terminal 102 can determine whether the criteria for setting SD-WAN tunnels with a new SD-WAN gateway have been satisfied before initiating setting up of SD-WAN tunnels with an SD-WAN gateway that is obtained from the SD-WAN gateway location that has been selected as the new closest when the movement of the terminal has caused the terminal's modem to perform a switchover to a new wireless gateway. The criteria can include (i) undertaking a verification process after the determination a new closest SD-WAN gateway location (2) evaluation of the maturity of the last SD-WAN gateway registration.

In some implementations, terminal 102 may delay setting up of SD-WAN tunnels with an SD-WAN gateway for a threshold amount of time when a new SD-WAN gateway location has become the closest. Terminal 102's setting up of SD-WAN tunnels with an SD-WAN gateway in the new location can be delayed until the terminal has reliably verified that the SD-WAN gateway location is indeed the closest. In some implementations, terminal 102 can require the SD-WAN gateway location that has recently become the newly closest to consistently remain as such for a threshold amount of time. By requiring the SD-WAN gateway location to remain the closet for the threshold amount of time, terminal 102 can perform subsequent processes based on a reliable determination of the new closest SD-WAN gateway location.

In some implementations, terminal 102 can require a minimum waiting time to elapse since setting up of SD-WAN tunnels with the previously closest SD-WAN gateway before establishing SD-WAN tunnels with a new SD-WAN gateway that has recently become the closest. This procedure which validates the maturity of the previous SD-WAN gateway registration allows avoiding frequent terminal registration events in the datacenter that hosts the SD-WAN gateway. Frequent registration events in an SD-WAN gateway location can result in routing table instability in routers inside the datacenter, which can impact data forwarding performance by the routers.

In the example of FIG. 1B, ATG modem performs a switchover to ATG gateway 116-2 after movement of terminal 102 causes the modem to conduct a handover to ATG tower 123-2. In this example, a mobility management entity decides to connect ATG modem 110 to ATG gateway 116-2 because providing low latency connectivity is preferred over maintaining of client's persistent connections. This is one setting in system 100 where persistent client connections are maintained over the overlay SD-WAN network that is created by establishing SD-WAN tunnels.

At stage (G) in the example of FIG. 1B, terminal 102 decides to establish SD-WAN tunnels with SD-WAN gateway 120-2 when the criteria for establishing SD-WAN tunnels with a new SD-WAN gateway are satisfied. As such, terminal 102 can decide setup SD-WAN tunnels with SD-WAN gateway 120-2 when the location of SD-WAN gateway 120-2 has remained to be the closest to location of ATG gateway 116-2 for more than a threshold amount of time, e.g., 15 minutes, and when age of the previous SD-WAN gateway registration, i.e., age of registration with SD-WAN gateway 120-1, has exceeded the registration maturity threshold, e.g., 60 minutes. However, if the terminal 102 moves out of ATG Tower 123-2 coverage area and into a new ATG tower coverage area that is served by a different ATG gateway, then the terminal 102 may iterate through the processes of stages (B) through (H) again.

In some cases, movement of terminal 102 can cause ATG modem 110 to perform ATG gateway switchover before the terminal has had a chance to setup SD-WAN tunnels with an SD-WAN gateway in the new closest SD-WAN location. The ATG modem 110 may perform ATG gateway switchover before the terminal has the chance to setup the SD-WAN tunnels because the terminal has not finished the evaluation of whether the new SD-WAN gateway location has been consistently the closest for the minimum threshold amount of time. In these cases, terminal 102 may choose to carry over the amount of time an SD-WAN gateway location had been the closest to the previous ATG gateway location if the same SD-WAN location remains to be the closest after the ATG modem has performed a switchover to a new ATG gateway. In the same cases, accounting of the duration of time that an SD-WAN gateway location has been the closest starts from zero, when the SD-WAN gateway becomes the new closest, and the duration continues to aggregate if the same SD-WAN gateway location remains to be the closest consistently.

During stage (H) in the example of FIG. 1B, the terminal 102 can establish one or more SD-WAN tunnels with SD-WAN gateway 120-2 when the criteria for setting up SD-WAN tunnels at a new SD-WAN location are satisfied. In some implementations, the terminal 102 can initiate setting up of the one or more SD-WAN tunnels in response to confirming the criteria for setting up SD-WAN tunnels at a new SD-WAN location, e.g., stage (G), are met. As illustrated in the example of system 100, the terminal 102 can establish a secure overlay SD-WAN network by setting up SD-WAN tunnels with the SD-WAN gateway 120-2. In the example of FIG. 1B, the terminal 102 can establish multiple SD-WAN tunnels with the SD-WAN gateway 120-2 where there is dedicated SD-WAN tunnel per WAN transport and Class-Of-Service combination.

The terminal 102 can establish an SD-WAN tunnel 2A to SD-WAN gateway 120-2 over the GEO transport and another SD-WAN tunnel 2B to the SD-WAN gateway 120-2 over the ATG transport. In some cases, the terminal 102 can establish another SD-WAN tunnel over the LEO transport to the SD-WAN gateway 120-2 when the terminal is commissioned with GEO+LEO transport combination or GEO+ATG+LEO transport combination. In some examples, as illustrated in FIG. 1B, the SD-WAN router 112 can establish an SD-WAN tunnel 2A through the GEO satellite modem 106, the GEO satellite antenna 104, the GEO satellite beam 122-2, the GEO gateway 2-130, and to the SD-WAN gateway 120-2. In some examples, the SD-WAN router 112 can establish an SD-WAN tunnel 2B through the ATG modem 110, the ATG antenna 108, the ATG tower 123-2, the ATG gateway 116-2, and to the SD-WAN gateway 120-2. Similarly, the SD-WAN router 112 can establish an SD-WAN tunnel through the LEO satellite modem, the LEO satellite antenna, the LEO satellite, the LEO gateway, and to the SD-WAN gateway 120-2. In some cases, SD-WAN router 112 and SD-WAN gateway 120-2 can setup more than one SD-WAN tunnels over any of the transports when setting up of SD-WAN tunnels in a per WAN and Class-Of-Service combination is required. In this manner, the terminal 102 can select from one of the multiple SD-WAN tunnels to transmit client data to the SD-WAN gateway 120-2 in the upstream direction. Similarly, SD-WAN gateway 120-2 can select from one of the multiple SD-WAN tunnels when it needs to transmit client data to terminal 102 in the downstream direction.

During stage (I) in the example of FIG. 1B, the terminal 102 can maintain the previously and the newly established SD-WAN tunnels at the same time. The previous set of SD-WAN tunnels 1A and 1B are those which were established with the SD-WAN gateway that was the closest previously, e.g., location 1. The new SD-WAN tunnels 2A and 2B are those which are setup with the SD-WAN gateway that has newly become the closest, e.g., location 2. In further detail, the terminal 102 can maintain the two sets of SD-WAN tunnels simultaneously when movement of the terminal 102 has caused one the terminal's modems to perform a wireless gateway switchover and a new SD-WAN gateway location has the lowest latency path. Maintaining of the previous set of SD-WAN tunnels is required when preserving persistent client connections. Otherwise, the previous set of tunnels can be terminated as soon as the new SD-WAN tunnels have been fully setup.

As illustrated in FIG. 1A, the first set of SD-WAN tunnels 1A and 1B originate from the SD-WAN router 112 and traverse to the SD-WAN gateway 120-1 over the GEO and the ATG transports, respectively. The terminal 102 maintains the first set of SD-WAN tunnels 1A and 1B along with the second set of SD-WAN tunnels 2A and 2B when terminal 102 is configured to preserve persistent client connections which were initially carried by the previous SD-WAN tunnels. SD-WAN overlay network that is created by setting up SD-WAN tunnels changes its path dynamically as the underlay network changes. In example of FIG. 1B, SD-WAN tunnel 1B changes its path when ATG modem 110 has switched over to ATG gateway 116-2 at location 2. In this example, SD-WAN tunnel 1B migrates from ATG gateway 116-1 to ATG gateway 116-2 when ATG modem has switched to ATG gateway 116-2 at location 2. Client traffic that is carried by SD-WAN tunnel 1B may experience brief outage while ATG gateway handover is underway if the handover process is not seamless. The extent of the outage is dependent upon how the ATG system manages gateway handover.

As illustrated in FIG. 1B, SD-WAN tunnel 1B can have a significantly higher latency compared to SD-WAN tunnel 1A since the distance from ATG gateway 116-2 to SD-WAN gateway 120-2 is shorter than the distance from ATG gateway 116-2 to SD-WAN gateway 120-1.

In some implementations, existing terminal 102 maintains connections that were initially carried by SD-WAN tunnels 1A and 1B on the same SD-WAN tunnels even after movement of terminal 102 to location 2 has caused ATG modem 110 to switchover to ATG gateway 116-2. New client connections that begin after the new SD-WAN tunnels 2A and 2B have been setup will be carried by the new SD-WAN tunnels.

In some examples, the existing client connections that were initiated prior to the ATG gateway switchover are maintained through the first set of SD-WAN tunnels 1A and 1B through the network 101 and may experience increased latency over time. However, any new connections created following the ATG gateway switchover and the selection of the new SD-WAN gateway are maintained through the second set of SD-WAN tunnels 2A and 2B to the SD-WAN gateway 120-2. The new connections through the second set of SD-WAN tunnels 2A and 2B can have lower latency as compared with the existing client connections on the first set of SD-WAN tunnels 1A and 1B. In some implementations, the terminal 102 can work with two or more SD-WAN gateways concurrently and can maintain multiple sets of SD-WAN tunnels.

However, the maximum number of SD-WAN gateways that SD-WAN router 112 can work with concurrently can be limited by several factors. The limiting factors may include, for example, availability of resources on the terminal, e.g., memory and processing power, and availability of resources on each of the SD-WAN gateways, e.g., memory and processing power. In some examples, a designer of system 100 can allow network operator to control the maximum number of SD-WAN gateways that terminal 102 can work with concurrently using configuration parameters.

In some implementations, the SD-WAN router 112 can tear down existing SD-WAN tunnels established with a previous SD-WAN gateway when it needs to setup SD-WAN tunnels with a new SD-WAN gateway, but terminal 102 is resource constrained. For example, prior to stage (A) in system 100, SD-WAN router 112 can receive a configuration parameter that limits the maximum number of concurrent SD-WAN gateways registrations to three. Other numbers of concurrent SD-WAN gateway registrations are also possible. After stage (I), the SD-WAN router 112 can setup SD-WAN tunnels with another SD-WAN gateway 3-134 as the terminal 102 moves further away from location 2 and changes its locations.

After moving to location 3 and setting up one or more SD-WAN tunnels with SD-WAN gateway 3-134, the SD-WAN router 112 can: (i) maintain the SD-WAN tunnels 1A and 1B with SD-WAN gateway 120-1, (ii) maintain the SD-WAN tunnels 2A and 2B with SD-WAN gateway 120-2, and (iii) maintain SD-WAN tunnels 3A and 3B with SD-WAN gateway 3-134. If the terminal 102 continues to travel further to location 4 and needs to setup SD-WAN tunnels with a new SD-WAN gateway 4-134 that becomes the closest when terminal 102 is at location 4, for example the terminal 102 must first tear down one of its older SD-WAN gateway registrations prior to setting up SD-WAN tunnels with SD-WAN gateway 4-134 because SD-WAN router 112 has reached the maximum limit for the number of concurrent SD-WAN gateway registrations, which is three in this case. However, other examples are also possible.

In some implementations, terminal 102 can choose to tear down its oldest SD-WAN gateway registration, e.g., the SD-WAN gateway to which SD-WAN router 112 was registered with the longest. For example, the SD-WAN router 112 can track the age of each SD-WAN gateway registrations to determine the oldest SD-WAN gateway registration.

In some implementations, terminal 102 can choose to tear down its SD-WAN gateway registration that is utilized the least. For example, the SD-WAN router 112 can determine system utilization by taking count of active client connections per connected SD-WAN gateway or by measuring the traffic receive and transmit rate over each of the SD-WAN tunnels. For example, the terminal 102 can monitor the utilization of the SD-WAN tunnels established with one or more SD-WAN gateways over a period of time. Terminal 102 can decide to tear down SD-WAN tunnels established with an SD-WAN gateway when the aggregate data utilization across all the SD-WAN tunnels that gateway over the period of time does not satisfy a criterion, e.g., does not meet or exceed a specified threshold. If the aggregate data transfer amount for SD-WAN tunnels established with an SD-WAN gateway does not exceed 1 Gigabyte (1 GB) in one hour, for example, or if the aggregate data transfer amount for the SD-WAN tunnels does not exceed 100 GBs in five hours, for example, then the terminal 102 can decide to tear down the SD-WAN tunnels established with the SD-WAN gateway. Other examples are also possible. When two or more SD-WAN gateways satisfy the data utilization criterion, terminal 102 can decide to tear down the SD-WAN tunnels of the SD-WAN gateway that has the lowest aggregate data utilization. Similarly, the terminal 102 can monitor the minimum latency to one or more SD-WAN gateways that the terminal has established SD-WAN tunnels with over a period of time. The terminal 102 can decide to tear down the SD-WAN tunnels established with an SD-WAN gateway that has a minimum latency that satisfies a criterion, e.g., meets or exceeds a threshold. For example, terminal 102 can decide to tear down SD-WAN tunnels established with an SD-WAN gateway when the minimum latency measured for that SD-WAN gateway over an hour period exceeds a threshold of 300 milliseconds. Other examples are also possible. When two or more SD-WAN gateways satisfy the minimum latency criterion, terminal 102 can decide to tear down the SD-WAN tunnels of the SD-WAN gateway that has the highest minimum latency.

FIG. 1C is a diagram that shows an example of a system 100 for selecting the SD-WAN gateway that provides the lowest latency path when terminal 102 modem performs a wireless gateway switchover. The example of FIG. 1C is a continuation of the flow diagrams illustrated in FIG. 1A and FIG. 1B. FIG. 1C illustrates various operations in stages (J) through (K), which can be performed in the sequence indicated, in another sequence, with fewer stages, or with more stages.

During stage (J), after SD-WAN tunnels 1A and 1B are established and before SD-WAN tunnels 2A and 2B are established, SD-WAN tunnels 1A and 1B carry all client traffic to and from terminal 102. As illustrated in FIG. 1C of example system 100, the terminal 102 includes a client device 103-1 and a client device 103-N. Each client device 103-1 and client device 103-N communicates with the SD-WAN router 112 over a local area network (LAN). The LAN may be, for example, wired Ethernet, e.g., 802.3, WiFi, or another type of LAN.

In the example of system 100, client device 103-1 on terminal 102 can forward or transmit a request 132 for data from a host in the Internet to the SD-WAN router 112. The client device 103-1 can forward the request 132 to SD-WAN router 112 at a time when SD-WAN tunnel 1A and SD-WAN tunnel 1B are established but prior to SD-WAN tunnels 2A and 2B are established. Accordingly, the SD-WAN router 112 can receive the request 132 and determine whether to transmit the request 132 to the SD-WAN gateway 120-1 over SD-WAN tunnel 1A or SD-WAN tunnel 1B.

In some implementations, the SD-WAN router 112 can decide whether to transmit data from one of the client's upstream connections (upstream IP flows) over a particular tunnel depending on numerous factors. The factors can include, for example, the priority level assigned to the IP flow, statuses of the WAN transports, and the performance requirement of the application that created the connection. Here, an IP flow is a TCP/IP connection initiated by one of client devices in the LAN. In some examples, an IP flow is uniquely identified for each unique combination of the five tuples, e.g., source IP address, destination IP address, source port, destination port and protocol.

System 100 can assign priority to an IP flow dynamically by analyzing the nature of the flow, where the assigned priority can be real-time, interactive, streaming or bulk. System 100 can also allow assignment of a desired priority for an IP flow that matches a classification rule. Some implementations may match an IP flow to a classification rule by comparing one or more of the flow's parameters, such as source IP address, destination IP address, source port, destination port and protocol to the rule's matching criteria.

In some implementations, the terminal 102 can monitor the status of a WAN transport by tracking the various characteristics of the WAN transport in real-time or substantial real-time. Specifically, the SD-WAN router 112 can track the WAN transport using tracked WAN characteristics that include, for example, connectivity, packet loss, latency, jitter, and capacity. For example, the terminal 102 can report the status of each of the WAN transports as CLEAN, SUSPECT, BROWNOUT, or BLACKOUT, to name a few examples, by evaluating the condition of the transport over a period. Transport in a CLEAN status can qualify the transport to be in an excellent condition. Transport in a SUSPECT status is in a slightly worse condition compared with the one in a CLEAN status, but the transport can be considered to be in a good condition to carry client traffic. Transport in a BROWNOUT status is in a worse condition compared to that in a SUSPECT transport status, and transport in this condition is almost unusable. Transport in a BLACKOUT transport status is in the worst condition and it can be completely unusable. Terminal 102 may evaluate the status of its WAN transport by comparing the measured of the transport's connectivity, the capacity, the latency, the jitter, and packet loss metrics to configured corresponding thresholds. For example, terminal 102 can determine a transport to be in a SUSPECT transport status when the transport's measured packet loss exceeds the threshold set for CLEAN.

In some implementations, the SD-WAN router 112 can integrate to an external element that performs deep-packet-inspection (DPI) and application recognition. The external system can tag packets of an IP flow started by an application with special marking, such as using DSCP code points or Type-Of-Service (ToS) that allows system 100 to identify the application behind the IP flow by checking the special marking on the flow's packets. This implementation requires system 100 to be configured with DSCP or TOS to application mapping or something similar whereas the external DPI entity is configured to apply specific DSCP or TOS to each of the packets of a given application or application category.

In some implementations, terminal 102 can be configured with application signature rules that defines a performance requirement for a given application or application group. The performance requirement for a given application or application group can specify sensitivities of the application to latency, jitter, capacity, connectivity, and packet loss conditions. The sensitivity of an application to any of the WAN characteristics can be low, medium, or high. For example, a real-time audio call application can have a high sensitivity for latency and jitter whereas a video streaming application may have low sensitivity to latency but high sensitivity to capacity.

Accordingly, the SD-WAN router 112 can select a specific SD-WAN tunnel 1A or 1B to transmit the request 132 from client device 103-1 after having analyzed the request's currently assigned priority level, the status of a WAN transport, and the performance requirement configuration that applies to the request 132. In some examples, the SD-WAN router 112 can select the SD-WAN tunnel 1A for transmitting the request 132 after determining: (i) the assigned priority level of the request 132 is streaming, (ii) the status of the GEO transport that carries the SD-WAN tunnel 1A is CLEAN, and (iii) the performance requirement configuration for the request 132 specifies that the request has low sensitivity to latency and high sensitivity for capacity. In this example, SD-WAN router 112 can determine to send request 132 via SD-WAN tunnel 1A because the tunnel is carried by GEO transport which has high capacity and high latency whereas the ATG transport is having low capacity and low latency. Other examples are also possible.

In some implementations, SD-WAN router 112 shares its configuration parameters with its connected SD-WAN gateway so that the SD-WAN gateway applies traffic handling policies derived from the configuration parameters to downstream client traffic corresponding to terminal 102.

In some implementations, the terminal 102 can maintain an existing client connection on the SD-WAN gateway that originally carried the connection. Terminal 102 may switch the client connection from one SD-WAN tunnel to another on the same SD-WAN gateway depending on the transport conditions and the performance requirements of the connection. In these implementations, terminal 102 will not switch a client connection from SD-WAN tunnel on one SD-WAN gateway to another SD-WAN tunnel on a different SD-WAN gateway as this may break the client connection. In some implementations, TCP connections from a client device can be proxied by a TCP spoofing agent that runs in the SD-WAN router 112 and its peer SD-WAN gateway when Performance Enhancing Proxy (PEP) is employed to improve the performance of TCP in the terminal that utilizes high-latency transports, such as GEO. System 100 can require terminal 102 to maintain TCP-spoofed client connections with the same SD-WAN gateway that originally managed the connection.

During stage (K) in the example of FIG. 1C, after terminal 102 has setup SD-WAN tunnels 2A and 2B, client connections can be actively carried on the two sets of tunnels, e.g., the first set of tunnels 1A and 1B and the second set of tunnels 2A and 2B. As illustrated in FIG. 1C of example system 100, the SD-WAN router 112 established SD-WAN tunnels 2A and 2B with SD-WAN gateway 120-2 through GEO gateway 2-130 and ATG gateway 116-2, respectively. New client connections that are starting after stage (K) are carried by the new SD-WAN tunnels 2A and 2B. However, old client connection that started prior to setting up of SD-WAN tunnels 2A and 2B are maintained on SD-WAN tunnels 1A and 1B.

In some implementations, client traffic that goes out to a host in the public Internet is anchored by the network edge device at the SD-WAN gateway location. In such implementations, system of 100 needs to ensure that return traffic from the host in the public Internet comes back to the same SD-WAN gateway location.

In some implementations, the network edge device in the SD-WAN gateway location can perform Network Address and Port Translation (NAPT) before upstream going client packet leaves the SD-WAN gateway location. NAPT operation is necessary if the packet's source IP address is not routable in the global domain, e.g., in the public Internet space. In particular, the edge device that performs NAPT operations derives the translated source IP address from the public IP subnet that is allocated to the network in the SD-WAN gateway location and is routable in the global domain. An upstream client packet from terminal 102 can include a source IP address that is derived from the subnet that is assigned to terminal 102 for use in its LAN.

The SD-WAN gateway advertises the terminal 102's LAN subnet to the layer-3, e.g., routing layer in the TCP/IP stack, devices in SD-WAN gateway location when the terminal 102 has setup SD-WAN tunnels with the SD-WAN gateway in stage (H). Any layer-3 node in the SD-WAN gateway location that can be involved in forwarding of client packets in the upstream, downstream or both directions need to receive a routing update that includes the LAN subnet used by terminal 102. This allows downstream traffic coming from the public Internet and going to terminal 102 to be routed back to the SD-WAN gateway that has setup SD-WAN tunnels with the terminal. Typically, the LAN subnet that is assigned to terminal 102 is unique at system 100 level so that no conflicts will exist in the SD-WAN gateway location.

In some implementations, terminal 102 can be limited to a single active SD-WAN gateway registration per SD-WAN gateway location. This may be necessary to avoid a routing conflict which can occur if the terminal registers with two or more SD-WAN gateways in the same SD-WAN location. In some implementations, SD-WAN gateway location does not advertise terminal 102's LAN subnet to routing peers outside of the SD-WAN gateway location. This can be necessary to avoid any routing confusions when two or more SD-WAN gateway locations advertise the same LAN subnet, which can happen when terminal 102 has established SD-WAN tunnels with two or more SD-WAN gateways at two or more SD-WAN locations.

The examples of FIGS. 1A-1C illustrate the terminal 102 operates with a GEO+ATG transport combination. In some implementations, the terminal 102 may instead have a GEO+LEO transport combination. In this case, the techniques and methods that terminal 102 uses to manage SD-WAN tunnels with the GEO+ATG transport combination in FIGS. 1A-1C can apply when terminal 102 is operating with GEO+LEO transport combination. Similarly, in some implementations, the same techniques and methods may apply when terminal 102 is operating with LEO+ATG transport combination. In a yet another example, the same techniques and methods can apply when terminal 102 is operating with GEO+LEO+ATG transport combination.

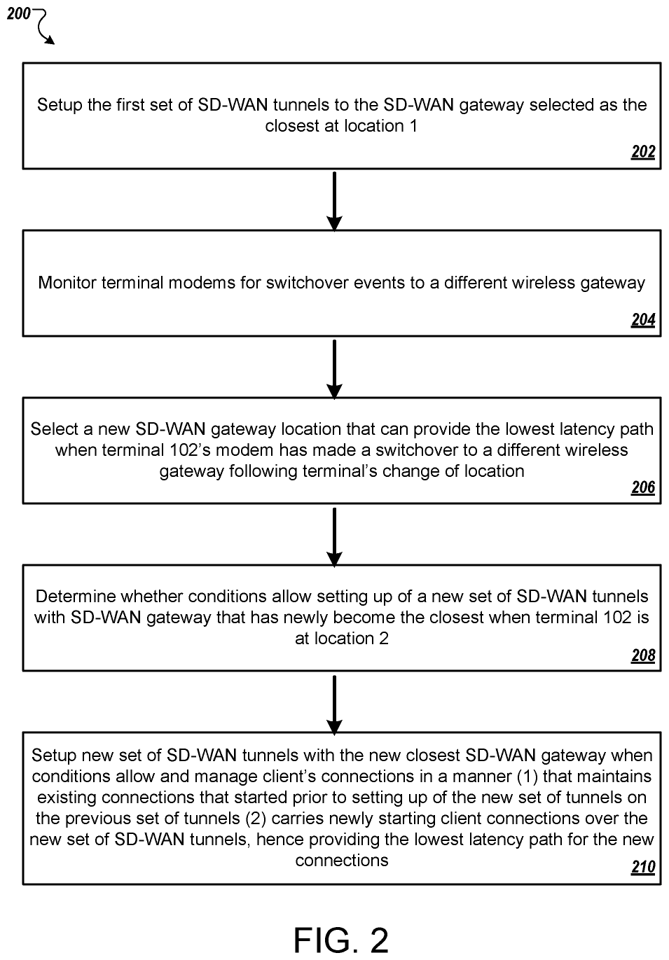

FIG. 2 is a flow diagram that illustrates an example process 200 for dynamically selecting an SD-WAN gateway and managing SD-WAN tunnels. A terminal, such as terminal 102 from system 100, can perform the process 200.

A terminal can setup the first set of SD-WAN tunnels to the SD-WAN gateway that is selected as the closest at location 1 (202). For example, the terminal 102 can establish SD-WAN tunnel 1A with the SD-WAN gateway over the ATG transport. The terminal 102 can establish SD-WAN tunnel 1B with the SD-WAN gateway over the GEO transport. Terminal 102 can transmit packets of upstream client connections on SD-WAN tunnel 1A or 1B. Similarly, the SD-WAN gateway can transmit packets of downstream client connections over SD-WAN tunnels 1A or 1B. The selection of SD-WAN tunnel to carry client connection packets depends on numerous factors described in earlier paragraphs.

The terminal can monitor terminal modems to detect when they have performed a switchover to a different wireless gateway following change of location by the terminal (204).

The terminal can select a new SD-WAN gateway location that can provide the lowest latency path when one of the terminal's modems, typically the low latency WAN modem, has made a switchover to a different wireless gateway following terminal's change of location (206).

The terminal can determine whether conditions allow setting up of a new set of SD-WAN tunnels with SD-WAN gateway that has newly become the closest when terminal 102 is at a new location (208). An earlier paragraph describes the conditions that allow or disallow setting up new SD-WAN tunnels with a new SD-WAN gateway. In some cases, a terminal can prompt the creation of new tunnels for multiple modems when a change in wireless gateway for one modem is detected.

The terminal can setup new set of SD-WAN tunnels with the new closest SD-WAN gateway when conditions allow (210). The terminal can, then, manage client's connections in a manner (1) that maintains existing connections that started prior to setting up of the new set of tunnels on the previous set of tunnels (2) carries newly starting client connections over the new set of SD-WAN tunnels, hence providing the lowest latency path for the new connections. In some implementations, the processes performed with respect to the process 200 can be performed by multiple separate devices.

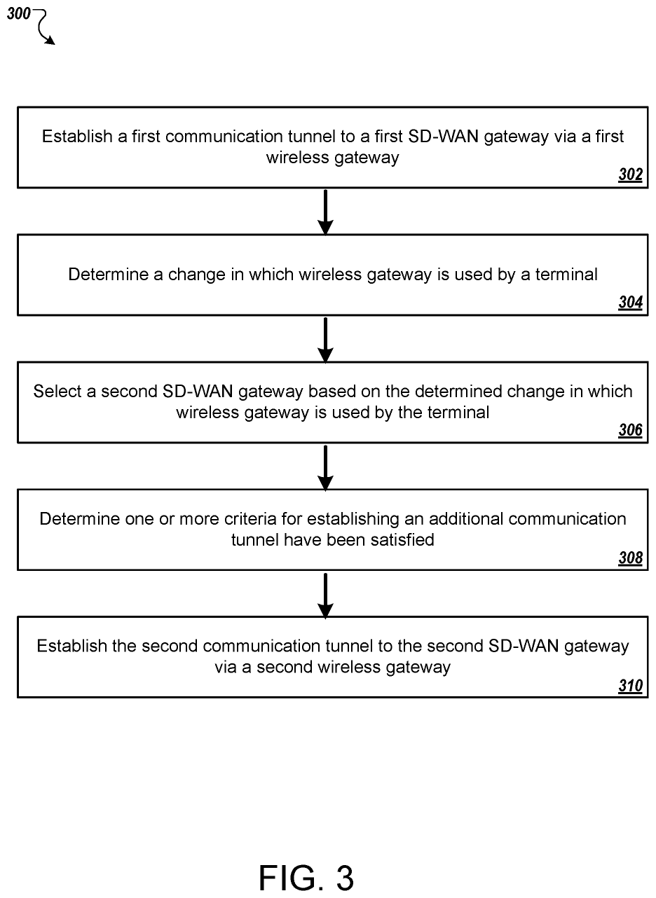

FIG. 3 is a flow diagram that illustrates an example process 300 for dynamically selecting an SD-WAN gateway and managing communication tunnels. A terminal, such as terminal 102 from system 100, can perform the process 300.

A terminal can establish a first communication tunnel to a first SD-WAN gateway via first wireless gateway (302). For example, the terminal 102 can establish an SD-WAN tunnel to the first SD-WAN gateway via the first wireless gateway. The terminal 102 can establish the SD-WAN tunnel to the first SD-WAN gateway over a GEO communication medium, a LEO communication medium, or an ATG communication medium, according to the components utilized by the terminal 102. The SD-WAN tunnel enables client devices that locally communicate with the terminal 102 to transmit data to the first SD-WAN gateway via the first wireless gateway in a secure manner.

The terminal can determine a change in which wireless gateway is used by the terminal (304). For example, the terminal 102 can use a modem to communicate through the first communication tunnel via the first wireless gateway. After the terminal 102 establishes the first communication tunnel, the terminal 102 can determine that the modem has switches to communicate with a second wireless gateway that is different from the first wireless gateway. For example, the terminal 102 can determine that its modem has switched to communicate with the second wireless gateway due to a movement of the terminal from a first geographic location to a second geographic location. In some examples, the terminal 102 can determine that the modem has switched to communicate with the second wireless gateway that is different from the first wireless gateway due to a change of geographic location of the terminal. In some examples, the terminal 102 can determine that the modem has switched to communicate with the second wireless gateway that is different from the first wireless gateway by monitoring a status of the modem over a period of time to detect a change in wireless gateway used by the modem.

The terminal can select a second SD-WAN gateway based on the determined change in which wireless gateway is used by the terminal (306). In response to the terminal 102 determining that the modem is communication with the second wireless gateway, the terminal 102 can access a set of multiple SD-WAN gateways. The terminal 102 can select a second SD-WAN gateway from the accessed set of multiple SD-WAN gateways based on a relationship between the second wireless gateway and the second SD-WAN gateway. In some examples, the terminal 102 can select the second SD-WAN gateway from the set of multiple SD-WAN gateways according to a distance between a location of the second SD-WAN gateway and the second wireless gateway satisfying a first threshold value. In some examples, the terminal 102 can select the second SD-WAN gateway from the set of multiple SD-WAN gateways by determining a latency value according to a communication between the second wireless gateway and the SD-WAN gateway, for each SD-WAN gateway of the set of multiple SD-WAN gateways. Accordingly, the terminal 102 can select the second SD-WAN gateway as the SD-gateway whose latency value satisfies a second threshold value.

The terminal can determine one or more criteria for establishing an additional communication tunnel have been satisfied (308). For example, the one or more criteria can include (i) that the relationship between the second wireless gateway and the second SD-WAN gateway is maintained for at least a minimum amount of time, and/or (ii) that the SD-WAN router has been registered to the first SD-WAN gateway for at least a minimum amount of time. The terminal 102 can determine whether the first portion of the criteria is met, the second portion of the criteria is met, or whether both portions of the criteria is met.

The terminal can establish the second communication tunnel to the second SD-WAN gateway via a second wireless tunnel (310). For example, in response to determining that the one or more criteria for establishing an additional communication tunnel have been satisfied, the terminal 102 can establish a second communication tunnel. The second communication tunnel can be established between the SD-WAN router and the second SD-WAN gateway while maintaining the first communication tunnel. In this manner, the terminal 102 is configured to provide data through the second communication tunnel via the second wireless gateway and concurrently provide data through the first communication tunnel via the first wireless gateway. In some implementations, the processes performed with respect to the process 200 can be performed by multiple separate devices.

In some implementations, after establishing the first communication tunnel and before establishing the second communication tunnel, the terminal can establish one or more first network connections between one or more client devices and one or more remote servers through the first communication tunnel. For example, the terminal can establish one or more first network connection between one or more client devices and one or more remote servers over the Internet through the first communication tunnel. After establishing the second communication tunnel, the terminal can establish one or more second network connections between one or more client devices and one or more remote servers through the second communication tunnel. Here, the terminal can concurrently communicate with the one or more first network networks on the first communication tunnel and the one or more second network connections on the second communication tunnel.

In some implementations, the terminal can selectively route different types of traffic between the different communication tunnels. In further detail, the router can selectively route different types of traffic between (i) the first communication tunnel between the SD-WAN router, a first modem, and the first SD-WAN gateway and (ii) the second communication tunnel between the SD-WAN router, a second modem, and the second SD-WAN gateway. In some examples, a first type of traffic is routed over the one or more first network connections on the first communication tunnel and a second type of traffic is routed over the one or more second network connections on the second communication tunnel.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
establishing, by a terminal, one or more first communication tunnels between a SD-WAN router of the terminal and a first SD-WAN gateway via one or more modems, including a modem that is associated to a first wireless gateway;
after establishing the one or more first communication tunnels and carrying traffic from one or more client devices over the one or more first communication tunnels, detecting, by the terminal, that the modem has changed its association to a second wireless gateway that is different from the first wireless gateway;
in response to detecting that the modem has changed its association to the second wireless gateway, selecting, by the terminal, a second SD-WAN gateway from a set of multiple SD-WAN gateways based on a relationship between the second wireless gateway and the second SD-WAN gateway;
determining, by the terminal, whether one or more criteria for establishing an additional communication tunnel have been satisfied; and
in response to determining that the one or more criteria for establishing an additional communication tunnel have been satisfied, establishing, by the terminal, one or more second communication tunnels between the SD-WAN router and the second SD-WAN gateway while maintaining the one or more first communication tunnels that the SD-WAN router established with the first SD-WAN gateway.

2. The computer-implemented method of claim 1, wherein the one or more criteria comprise at least one of (i) the relationship between the second wireless gateway and the second SD-WAN gateway being maintained for at least a minimum amount of time, (ii) a limit for a maximum number of concurrently active SD-WAN registrations is not exceeded, or (iii) a minimum amount of time has elapsed since the SD-WAN router most recently established a communication tunnel with a SD-WAN gateway other than the second SD-WAN gateway.

3. The computer-implemented method of claim 1, wherein the one or more modems comprise multiple modems that associate to different wireless gateways; and
wherein the method comprises monitoring each of the multiple modems to detect when any of the multiple modems changes its association to a different wireless gateway.

4. The computer-implemented method of claim 1, wherein the terminal is configured to send and receive data through the one or more second communication tunnels via the second SD-WAN gateway and concurrently send and receive data through the one or more first communication tunnels via the first SD-WAN gateway.

5. The computer-implemented method of claim 1, comprising:
after establishing the one or more first communication tunnels with the first SD-WAN gateway and before establishing the one or more second communication tunnels, using the SD-WAN router to (i) transmit packets of a client connection over one of the first communication tunnels and (ii) receive packets of a client connection over one of the first communication tunnels; and
after establishing the one or more second communication tunnels:
maintaining communication over the first set of communication tunnels for existing client connections that started before the one or more second communication tunnels were established; and
routing packets over the second communication tunnels for client connections that started after the one or more second communication tunnels were established.

6. The computer-implemented method of claim 1, wherein detecting that the modem has changed its association comprises obtaining information from the modem using a signaling method between the terminal and the modem, and evaluating the information to detect when the modem's associated wireless gateway has changed.

7. The computer-implemented method of claim 1, wherein detecting that the modem has changed its association comprises detecting when one or more connections carried by the modem have changed to a different anchor point in a network of a wireless service provider.

8. The computer-implemented method of claim 7, comprising detecting a change in anchor point for one or more connections based on a change of source IP address in the one or more connections carried by the modem in the direction of transmission from the terminal to a SD-WAN gateway.

9. The computer-implemented method of claim 1, wherein selecting the second SD-WAN gateway from the set of multiple SD-WAN gateways based on the relationship between the second wireless gateway and the second SD-WAN gateway comprises:
selecting, from a set of multiple SD-WAN gateway locations, a second SD-WAN gateway location that has a shortest geographical distance to the location of the second wireless gateway.

10. The computer-implemented method of claim 1, wherein selecting the second SD-WAN gateway from the set of multiple SD-WAN gateways based on the relationship between the second wireless gateway and the second SD-WAN gateway comprises:
selecting, from a set of multiple SD-WAN gateway locations, a second SD-WAN gateway location that has a lowest latency for communication with the terminal.

11. The computer-implemented method of claim 10, comprising measuring latency from the terminal to the respective multiple SD-WAN gateway locations by exchanging latency probing messages between the terminal and a server at each of the respective SD-WAN gateway locations.

12. A terminal comprising:
one or more processors and one or more storage devices storing instructions that are operable, when executed by the one or more processors, to cause the terminal to perform operations comprising:
establishing, by a terminal, one or more first communication tunnels between a SD-WAN router of the terminal and a first SD-WAN gateway via one or more modems, including a modem that is associated to a first wireless gateway;
after establishing the one or more first communication tunnels and carrying traffic from one or more client devices over the one or more first communication tunnels, detecting, by the terminal, that the modem has changed its association to a second wireless gateway that is different from the first wireless gateway;
in response to detecting that the modem has changed its association to the second wireless gateway, selecting, by the terminal, a second SD-WAN gateway from a set of multiple SD-WAN gateways based on a relationship between the second wireless gateway and the second SD-WAN gateway;
determining, by the terminal, whether one or more criteria for establishing an additional communication tunnel have been satisfied; and
in response to determining that the one or more criteria for establishing an additional communication tunnel have been satisfied, establishing, by the terminal, one or more second communication tunnels between the SD-WAN router and the second SD-WAN gateway while maintaining the one or more first communication tunnels that the SD-WAN router established with the first SD-WAN gateway.

13. The terminal of claim 12, wherein the one or more criteria comprise at least one of (i) the relationship between the second wireless gateway and the second SD-WAN gateway being maintained for at least a minimum amount of time, (ii) a limit for a maximum number of concurrently active SD-WAN registrations is not exceeded, or (iii) a minimum amount of time has elapsed since the SD-WAN router most recently established a communication tunnel with a SD-WAN gateway other than the second SD-WAN gateway.

14. The terminal of claim 12, wherein the one or more modems comprise multiple modems that associate to different wireless gateways; and
wherein the method comprises monitoring each of the multiple modems to detect when any of the multiple modems changes its association to a different wireless gateway.

15. The terminal of claim 12, wherein that the terminal is configured to send and receive data through the one or more second communication tunnels via the second SD-WAN gateway and concurrently send and receive data through the one or more first communication tunnels via the first SD-WAN gateway.

16. The terminal of claim 12, comprising:
after establishing the one or more first communication tunnels with the first SD-WAN gateway and before establishing the one or more second communication tunnels, using the SD-WAN router to (i) transmit packets of a client connection over one of the first communication tunnels and (ii) receive packets of a client connection over one of the first communication tunnels;
after establishing the one or more second communication tunnels:
maintaining communication over the first set of communication tunnels for existing client connections that started before the one or more second communication tunnels were established; and
routing packets over the second communication tunnels for client connections that started after the one or more second communication tunnels were established.

17. The terminal of claim 12, wherein detecting that the modem has changed its association comprises obtaining information from the modem using a signaling method between the terminal and the modem, and evaluating the information to detect when the modem's associated wireless gateway has changed.

18. The terminal of claim 12, wherein detecting that the modem has changed its association comprises detecting when one or more connections carried by the modem have changed to a different anchor point in a network of a wireless service provider.

19. The terminal of claim 18, comprising detecting a change in anchor point for one or more connections based on a change of source IP address in the one or more connections carried by the modem in the direction of transmission from the terminal to a SD-WAN gateway.

20. One or more storage devices storing instructions that are operable, when executed by one or more processors, to cause the one or more processors to perform operations comprising:
establishing, by a terminal, one or more first communication tunnels between a SD-WAN router of the terminal and a first SD-WAN gateway via one or more modems, including a modem that is associated to a first wireless gateway;
after establishing the one or more first communication tunnels and carrying traffic from one or more client devices over the one or more first communication tunnels, detecting, by the terminal, that the modem has changed its association to a second wireless gateway that is different from the first wireless gateway;
in response to detecting that the modem has changed its association to the second wireless gateway, selecting, by the terminal, a second SD-WAN gateway from a set of multiple SD-WAN gateways based on a relationship between the second wireless gateway and the second SD-WAN gateway;
determining, by the terminal, whether one or more criteria for establishing an additional communication tunnel have been satisfied; and
in response to determining that the one or more criteria for establishing an additional communication tunnel have been satisfied, establishing, by the terminal, one or more second communication tunnels between the SD-WAN router and the second SD-WAN gateway while maintaining the one or more first communication tunnels that the SD-WAN router established with the first SD-WAN gateway.
